(19) United States
(12) Patent Application Publication
(10) Pub. No.: US 2026/0339598 A1
(43) Pub. Date: Oct. 29, 2026

(54) AUDIO PLAYBACK WITH ADAPTIVE PROCESSING CYCLES

(71) Applicant: QUALCOMM Incorporated, San Diego, CA (US)

(72) Inventors: Asif Imroz MOHAMMED, Hyderabad (IN); Anuj DESHMUKH, NAGPUR (IN)

(21) Appl. No.: 19/191,080

(22) Filed: Apr. 28, 2025

(51) Int. Cl. G06F 3/16; H04R 3/00

(52) U.S. Cl. CPC G06F 3/165; H04R 3/00

(57) ABSTRACT

Various aspects relate to audio playback with adaptive processing cycles. A processing cycle of an audio playback thread is dynamically updated based on an operating parameter associated with a device. Based on the operating parameter being within a first category, the processing cycle of the audio playback thread is set to a first duration of a plurality of durations. A change in the operating parameter is detected, and the processing cycle of the audio playback thread is reset to a second duration of the plurality of durations based on the changed operating parameter being within a second category of the plurality of categories.

### BACKGROUND

### Field of the Disclosure

The present disclosure relates generally to audio processing, and, more particularly, to managing audio playback.

### Description of Related Art

Audio playback is a widely used feature in today's devices (for example, smartphones, tablets, wearable electronics, smart televisions, and various additional computing devices), offering seamless media experiences across a wide range of applications such as entertainment and communication. Modern devices are capable of supporting varied audio playback use cases, which can involve real-time decoding and rendering of compressed audio content to various output devices such as speakers or headphones, while maintaining high fidelity and low latency.

During audio playback, audio data is delivered and processed through a series of device components and execution threads, for example, an application thread and an audio playback thread. These execution threads coordinate decoding and output operations and are scheduled at periodic intervals to manage chunks or portions of audio data. This scheduling may result in frequent thread wakeups, which can lead to elevated power usage throughout the duration of audio playback. As audio playback use cases continue to evolve and device usage increases, there are opportunities to optimize power consumption and enhance device longevity.

### SUMMARY

Aspects of the disclosure provide a device that includes one or more memories and one or more processors. The one or more memories are configured to store data related to a plurality of durations. The one or more processors individually or collectively are configured to set a processing cycle of an audio playback thread to a first duration of the plurality of durations based on an operating parameter associated with the device being within a first category of a plurality of categories and detect a change in the operating parameter. The changed operating parameter is within a second category of the plurality of categories. The one or more processors individually or collectively are configured to reset the processing cycle to a second duration of the plurality of durations based on the changed operating parameter being within the second category.

In certain aspects of the disclosure, a device is provided. The device comprises a rechargeable power source, one or more memories, and one or more processors. The one or more memories are configured to store data related to a plurality of durations. The one or more processors individually or collectively are configured to set a processing cycle of an audio playback thread to a first duration of the plurality of durations based on a state of charge (SoC) of the rechargeable power source being within a first SoC range of a plurality of SoC ranges. The one or more processors individually or collectively are configured to detect a change in the SoC. The changed SoC is within a second SoC range of the plurality of SoC ranges and reset the processing cycle to a second duration of the plurality of durations based on the changed SoC being within the second SoC range.

### BRIEF DESCRIPTION OF THE DRAWINGS

Various aspects of the present disclosure are illustrated by way of example, and not limited by the appended figures, in which like references indicate similar elements:

FIG. 1 is a block diagram illustrating a device that supports audio playback with adaptive processing cycles, in accordance with certain aspects of the present disclosure;

FIG. 2A is a diagram of an example scenario that illustrates various operations of an application thread across a time axis, in accordance with certain aspects of the present disclosure;

FIG. 2B is a diagram of an example scenario that illustrates various operations of an audio playback thread across a time axis, in accordance with certain aspects of the present disclosure;

FIG. 3 is a diagram of an example scenario that illustrates various operations of an audio playback thread across multiple processing cycles, where cycle durations are adapted based on operating parameter conditions such as State of Charge (SoC), in accordance with certain aspects of the present disclosure;

FIG. 4 is a diagram that illustrates various operations of the device that supports audio playback with adaptive processing cycles, in accordance with certain aspects of the present disclosure;

FIG. 5 is a high-level flowchart that illustrates a method (e.g., a process) for dynamically adapting a processing cycle of an audio playback thread, in accordance with certain aspects of the present disclosure;

FIG. 6 is a detailed flowchart that illustrates a method (e.g., a process) for dynamically adapting a processing cycle of an audio playback thread, in accordance with certain aspects of the present disclosure;

FIG. 7 is a high-level flowchart that illustrates a method (e.g., a process) executed at a device by an application thread, in accordance with certain aspects of the present disclosure;

FIG. 8 is a detailed flowchart that illustrates a method (e.g., a process) executed at a device by an audio playback thread that supports a faster-than-real-time processing, in accordance with certain aspects of the present disclosure;

FIG. 9 is a high-level flowchart that illustrates a method (e.g., a process) executed at a device by an audio playback thread that supports an adaptive processing cycle with faster-than-real-time processing, in accordance with certain aspects of the present disclosure;

FIG. 10 is a high-level flowchart that illustrates a method (e.g., a process) for dynamically adapting a processing cycle of an audio playback thread based on an SoC associated with a device, in accordance with certain aspects of the present disclosure;

FIG. 11 is a diagram that illustrates a first example implementation of the device of FIG. 1 that supports audio playback with adaptive processing cycles, in accordance with certain aspects of the present disclosure;

FIG. 12 is a diagram that illustrates a second example implementation of the device of FIG. 1 that supports audio playback with adaptive processing cycles, in accordance with certain aspects of the present disclosure;

FIG. 13 is a diagram that illustrates a third example implementation of the device of FIG. 1 that supports audio playback with adaptive processing cycles, in accordance with certain aspects of the present disclosure;

FIG. 14 is a diagram that illustrates a fourth example implementation of the device of FIG. 1 that supports audio playback with adaptive processing cycles, in accordance with certain aspects of the present disclosure;

FIG. 15 is a diagram that illustrates a fifth example implementation of the device of FIG. 1 that supports audio playback with adaptive processing cycles, in accordance with certain aspects of the present disclosure; and

FIG. 16 is a block diagram that illustrates a device operable to support audio playback with adaptive processing cycles, in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the disclosure will now be presented with reference to an apparatus and method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

At least one of a host processor, a processing core, an input/output controller, or any portion of any of such components, or any combination of such components may be implemented as a “processing system” that may include one or more processors. Examples of processor(s) include microprocessor(s), microcontroller(s), graphics processing unit(s), central processing unit(s), application processor(s), digital signal processor(s), reduced instruction set computing processor(s), systems on a chip, baseband processor(s), field programmable gate arrays, programmable logic devices, state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

A variety of electronic devices, ranging from mobile phones to home entertainment systems, offer audio playback functionality. The audio playback functionality may be facilitated by various execution threads, such as an application thread and an audio playback thread. The application thread, which is associated with a media application, supplies audio data to the audio playback thread. The audio playback thread then decodes and renders the audio data across various end devices, such as speakers and headphones.

To maintain seamless audio playback, the application thread wakes up and sends audio data to the audio playback thread, for example, every few milliseconds (ms). The frequency of these wake-ups can vary depending on the type of audio data being processed. Frequent wake-ups of the application thread to provide the audio data to the audio playback thread consume a significant amount of power. Additionally, although the audio playback thread can process the audio data in less time than the actual duration of the audio data (also referred to as faster-than-real-time processing), the audio playback thread is usually scheduled to operate in smaller, more frequent cycles to enhance playback performance, such as reducing latency.

In an example scenario, the application thread may be configured to wake every 15 ms to send 15 ms of audio data to the audio playback thread. Further, an audio processing frame size for the audio playback thread may be configured as 5 ms. In such a scenario, the application thread may wake up approximately 66 times per second. Moreover, the audio playback thread may remain active throughout the 15 ms duration to sequentially process 5 ms chunks of audio data according to the configured audio processing frame size. Although such a configuration enables seamless audio delivery, both the application thread and the audio playback thread are in a frequent state of wakefulness, which substantially increases the overall power consumption of the device. Maintaining clock speeds and memory accesses for the audio playback thread further exacerbates power consumption. In scenarios where the electronic device is battery-powered, such frequent wakefulness of the application thread and the audio playback thread and the associated high power consumption can significantly reduce battery life, impacting overall device longevity and user satisfaction. High power consumption caused due to frequent wake-ups can be reduced by statically increasing the audio processing frame size of the audio playback thread. For example, if the audio processing frame size of the audio playback thread is configured to 10 ms instead of 5 ms, power consumption can be reduced. However, increasing the audio processing frame size can lead to an increase in audio playback latency.

To address the aforementioned issues, along with other inefficiencies that affect performance and user experience, various aspects of the present disclosure provide a technical solution that leverages faster-than-real-time capability of an audio playback thread for audio playback optimization.

In many aspects, the present disclosure describes an audio playback thread whose processing cycle duration can be modulated or adaptively reset based on an operating parameter associated with a device executing the audio playback thread. For example, the processing cycle of the audio playback thread can be set to a first duration if the operating parameter is within a first category. Further, if there is a change in the operating parameter that shifts the operating parameter to a second category different from the first category, the processing cycle of the audio playback thread can be reset to a second duration, which can be longer or shorter than the first duration. The integration of adaptive processing cycles in the audio playback thread allows for a balance between latency and power consumption. By dynamically resetting the processing cycle duration based on changes in the operating parameter, the device can optimize for low power usage without compromising the responsiveness for high-quality audio playback.

In additional aspects, during the processing cycle having (or set to) the first duration, the audio playback thread may process first audio content having a first processing frame size, and during the processing cycle having (or reset to) the second duration, the audio playback thread may process second audio content having a second processing frame size. The second processing frame size is different from the first processing frame size. In other words, a processing frame size of the audio playback thread can be increased or decreased in accordance with the increase or decrease in the duration of the processing cycle, respectively.

In more aspects, the audio playback thread may transition to an active state at a start of the processing cycle, process audio content faster-than-real-time in the active state, and enter a sleep state for a residual time of the processing cycle based on a completion of the processing of the audio content. In scenarios where the processing cycle duration is adaptively increased, the residual time available for the audio playback thread to remain in the sleep state becomes longer. Such extended sleep duration may further reduce power consumption by allowing the audio playback thread to remain inactive or in a low power state for a greater portion of the processing cycle. As a result, the adaptive processing cycles align audio playback with operating conditions and improve energy efficiency by maximizing idle or low power time without compromising audio playback continuity.

In several aspects, the audio playback thread may acquire one or more resources based on a transition to the active state and release the acquired one or more resources based on a transition to the sleep state. Examples of the resource(s) may include a memory bandwidth (e.g., memory access votes) of the device or a clocking resource (e.g., clock votes). By allowing the audio playback thread to enter the sleep state for the remainder of the processing cycle, as enabled by faster-than-real-time processing, the audio playback thread can release the acquired resources when not in use. As a result, the ability to release clocks and memory accesses during the sleep state may further contribute to power savings.

In numerous aspects, one or more processors of the device may individually or collectively obtain the operating parameter to set or reset the processing cycle of the audio playback thread. In an example implementation, the processor(s) may obtain the operating parameter via the application thread. In further implementations, the processor(s) may obtain the operating parameter based on at least one of real-time monitoring, periodic sampling, or a trigger event.

In contrast to conventional audio playback approaches, where the audio playback thread remains continuously active throughout playback duration, the present disclosure leverages the faster-than-real-time processing capability of the audio playback thread to enable a transition to the sleep state within each processing cycle. As the processing cycle duration increases, the residual time the audio playback thread spends in the sleep state also increases, thereby enabling multiple power-saving configurations based on different processing cycle durations. Thus, the integration of adaptive processing cycles in audio playback allows the device to dynamically adjust energy consumption according to the configured processing cycle duration, without compromising audio playback continuity.

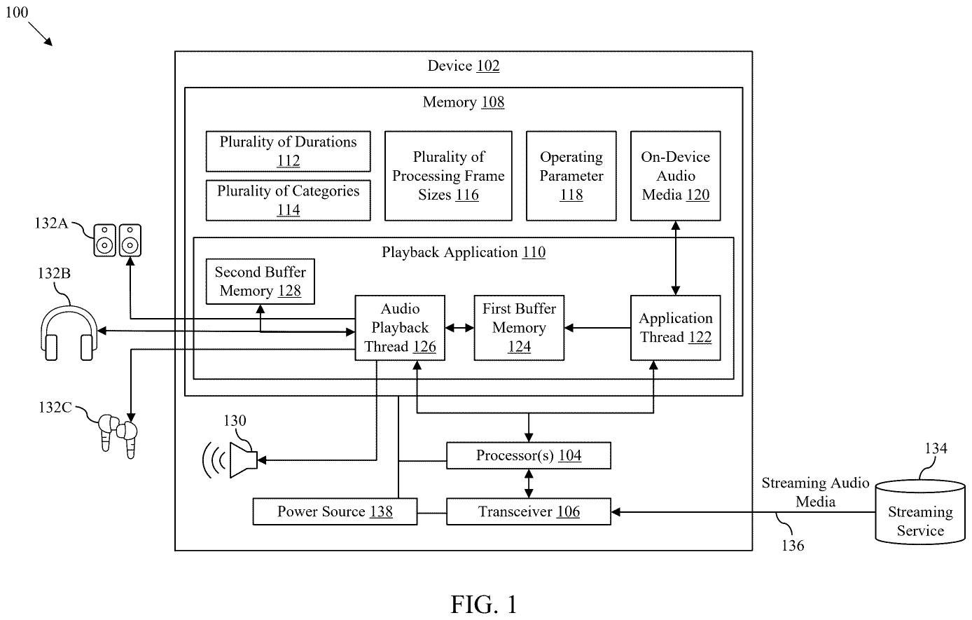

FIG. 1 is a block diagram 100 illustrating a device 102 that supports audio playback with adaptive processing cycles, in accordance with certain aspects of the present disclosure. Examples of the device 102 may include a smartphone, a laptop, a personal computer, a tablet, wearable electronics, a smart television, an Internet of Things (IoT) device, an extended reality (XR) device (e.g., a virtual reality “VR” device, a mixed reality “MR” device, or an augmented reality “AR” device), or various additional computing devices. In many aspects, the device 102 may include one or more processors 104, a transceiver 106, and one or more memories (e.g., a memory 108).

In many aspects, the processor(s) 104 may include, for example and without limitation, one or more central processing units (CPUs), Graphics Processing Units (GPUs), one or more Reduced Instruction Set Computing (RISC) processor(s), one or more Application-Specific Integrated Circuit (ASIC) processor(s), one or more Complex Instruction Set Computing (CISC) processor(s), one or more microcontrollers, one or more audio signal processor(s), or additional computing processor(s) to individually or collectively perform one or more functions described herein. As used herein, the phrase ‘one or more processors individually or collectively configured to’ may encompass various aspects, including but not limited to: a single processor executing all functions; multiple processors, each performing different aspects of the function independently; multiple processors operating in coordination to execute a function collectively; or any combination thereof, where different processors may dynamically (e.g., concurrently or sequentially) assume responsibilities based on system conditions.

The processor(s) 104 may include one or more specialized processors, which may include electronic circuits or other electronic hardware, such as one or more programmable electronic circuits. In some aspects, the processor(s) 104 may implement or execute computer software, firmware, or any combination thereof, to perform the various operations described herein. The software and/or firmware may include one or more instructions stored on a computer-readable storage medium and executable by the processor(s) 104. The processor(s) 104 may individually or collectively perform various operations, for example, to optimize energy performance of the device 102, while allowing audio playback continuity. In various aspects, the processor(s) may be coupled to the one or more memories, for example, the memory 108.

In many aspects, the memory 108 may include, for example and without limitation, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card. The memory 108 may be configured to store the program instructions executable by the processor(s) 104. In many aspects, the memory 108 may be configured to store one or more playback applications, one example of which is represented as a playback application 110 in FIG. 1.

In further aspects, the memory 108 may be configured to store data, settings, configurations, or the like that allow the device 102 to support audio playback with adaptive processing cycles. In an example, the memory 108 may store data related to a plurality of durations 112, and additionally, one or more of: a plurality of categories 114, a plurality of processing frame sizes 116, and an operating parameter 118 associated with the device 102. In many aspects, the memory 108 can also store on-device audio media 120 for rendering.

In many aspects, the playback application 110 may refer to an executable program or a software framework that orchestrates audio playback on the device 102. For example, the playback application 110 may enable the device 102 to decode, render, and deliver audio media to end output devices 130 and 132A-132C, for example, an internal speaker 130, an external speaker 132A, or headphones 132B, 132C. In an example, the audio media may correspond to the on-device audio media 120 stored locally in the memory 108 or streaming audio media 136 received from a streaming service 134. In various examples, the playback application 110 may further support a plurality of additional functionalities, such as, but not limited to, streaming protocol handling, audio format conversion, bitrate adaptation, content metadata processing, user preference learning, and user interaction features such as playlist management or playback controls. In many aspects, the playback application 110 may include an application thread 122, a first buffer memory 124, an audio playback thread 126, and a second buffer memory 128.

The application thread 122 may refer to a processor-executable thread configured to manage audio data acquisition and coordination within the playback application 110. For example, the application thread 122 may be configured to obtain audio data associated with an audio media from the memory 108 or the streaming service 134. The application thread 122 may be further configured to store the obtained audio data in the first buffer memory 124. In this context, the process of obtaining and storing the audio data may be executed within a processing cycle of the application thread 122. The processing cycle may refer to a time-bounded interval at the start of which the application thread 122 transitions to an active state to perform data acquisition and buffering tasks (e.g., obtaining the audio data and storing in the first buffer memory 124), and subsequently enters a sleep state for a remainder of the time until the next processing cycle starts. The processing cycle may be configured to repeat periodically after a launch of the application thread 122, continuing at least until the audio playback is terminated. As a result, the application thread 122 may periodically transition between the active state to obtain the audio data and the sleep state upon the storage of the obtained audio data. In further aspects, the application thread 122 may be further configured to handle playback state transitions such as play, pause, seek, or the like, based on user inputs.

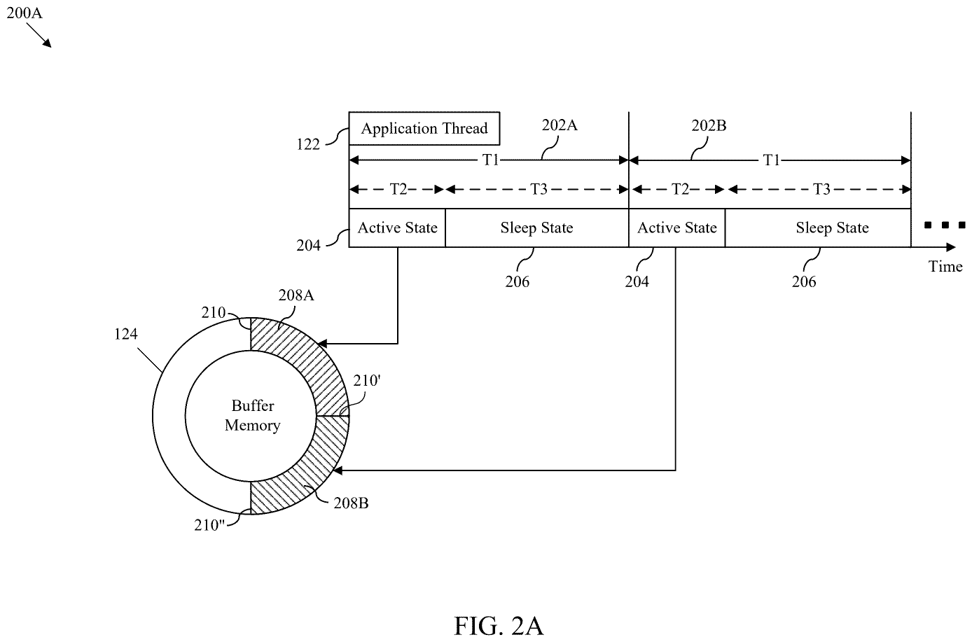

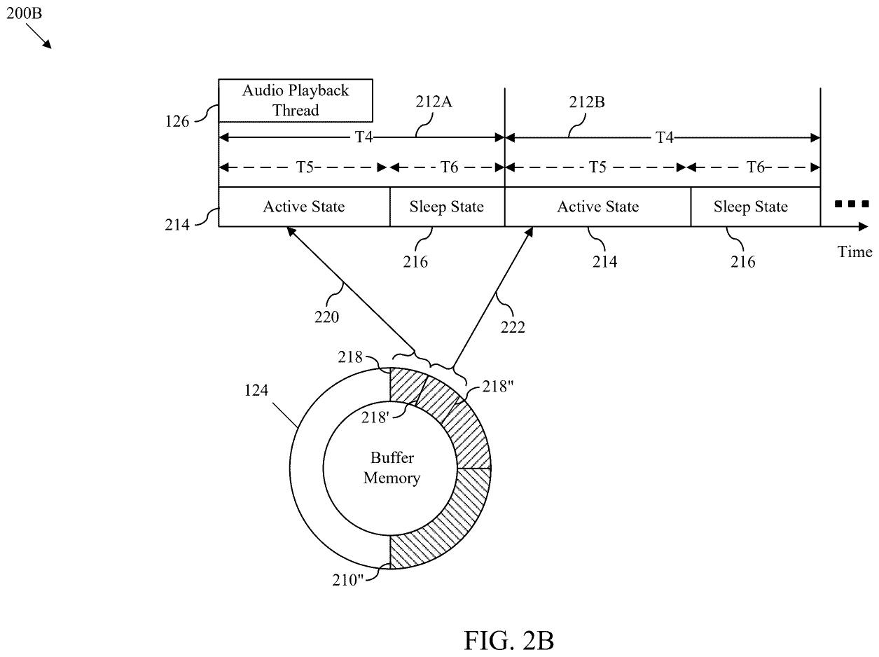

The first buffer memory 124 may correspond to a shared memory element accessible by the application thread 122 and the audio playback thread 126. For example, the first buffer memory 124 may enable audio data exchange between the application thread 122 and the audio playback thread 126. In a non-limiting example, the first buffer memory 124 may correspond to a circular buffer memory with dynamic head and tail markers. The first buffer memory 124 is described in further detail in conjunction with FIGS. 2A and 2B.

The audio playback thread 126 may refer to a processor-executable thread configured to decode and process audio content for output. In an example, the audio playback thread 126 may be configured to read encoded audio content from the first buffer memory 124, decode the read audio content, and store the decoded audio content in the second buffer memory 128. This sequence of operations (e.g., reading the encoded audio content, decoding the read audio content, and storing the decoded audio content) may be carried out by the audio playback thread 126 within a processing cycle of the audio playback thread 126. The processing cycle may refer to a defined time interval at the start of which the audio playback thread 126 transitions to an active state, processes audio content faster-than-real-time, and subsequently enters a sleep state for a residual time of the processing cycle based on a completion of the processing of the audio content. Faster-than-real-time may refer to the capability of the audio playback thread 126 to process (e.g., such as decoding, buffering, and rendering) audio content of a given frame size in less time than an actual playback duration (e.g., the frame size) of that audio content. For example, if audio content represents 50 ms of playback time, the audio playback thread 126 may complete processing of the audio content in 5 ms to 10 ms. This approach may allow for reduced power consumption while maintaining continuous playback. In some aspects, the processing cycle may repeat periodically after a launch of the audio playback thread 126, continuing at least until the audio playback is terminated. As a result, the audio playback thread 126 may periodically transition between the active state to process the audio content and the sleep state upon the completion of the processing.

In more aspects, the processing cycle of the application thread 122 may be configured to be an order of magnitude greater, such as 10 times, 20 times, or more, than the processing cycle of the audio playback thread 126. Such an extent of decoupling may enable the application thread 122 to wake far less frequently than the audio playback thread 126, thereby significantly reducing thread wakeups, memory access operations, and thread scheduling overhead with regard to the application thread 122. In an example, the application thread 122 and the audio playback thread 126 may correspond to software routines scheduled to run on the processor(s) 104.

The second buffer memory 128 may correspond to a memory element that is configured to store the audio content processed by the audio playback thread 126. In an example, the second buffer memory 128 may serve as a final staging buffer before the audio content is provided to the end output devices 132A-132C for outputting.

In still more aspects, the device 102 may be coupled to the streaming service 134 or additional external devices or systems via the transceiver 106. The transceiver 106 may refer to an electronic component that may be a combination of a transmitter and a receiver, thereby allowing two-way communication between the processor(s) 104 and the streaming services 134. For example, the transceiver 106 may be configured to transmit a stream request to the streaming service 134 and in response receive the streaming audio media 136 from the streaming service 134.

In several aspects, the streaming service 134 may correspond to a platform that delivers digital content (for example, the streaming audio media 136) over Internet in real-time or on user request. In an example implementation, the streaming service 134 may provide the streaming audio media 136 to the device 102 for audio playback without downloading the streaming audio media 136. In an example, but not limitation, the streaming audio media 136 may include on-demand audio media, live audio media, podcasts, audiobooks, movies, and the like.

In numerous aspects, the device 102 may include a power source 138 coupled to the processor(s) 104, the transceiver 106, and the memory 108. The power source 138 may be configured to provide electrical energy to operate one or more components (for example, the processor(s) 104, the transceiver 106, and the memory 108) of the device 102. In a non-limiting example, the power source 138 may correspond to a rechargeable battery associated with the device 102. In further examples, the power source 138 can be an alternating current (AC) power associated with the device 102.

In various aspects, the audio playback thread 126 may be configured to support an adaptive processing cycle. The memory 108 may be configured to store various configurations, settings, and control data that enable the audio playback thread 126 to support the adaptive processing cycle. For example, the memory 108 may store the plurality of durations 112, each defining a different length of the processing cycle that the audio playback thread 126 can operate with. Examples of the plurality of durations 112 may include 20 ms, 50 ms, 100 ms, 200 ms, or the like. Further, processing cycles of different durations may support different corresponding sleep state durations. For same type of processing operations, a shorter processing cycle (e.g., 25 ms) may have a smaller portion (e.g., 10 ms) of the processing cycle for the sleep state, while a longer processing cycle (e.g., 100 ms) may support a significantly longer duration (e.g., 60 ms) in the sleep state.

Corresponding to the plurality of durations 112, the memory 108 may also store the plurality of processing frame sizes 116, where each processing frame size may specify an amount of audio data that the audio playback thread 126 is configured to process within the processing cycle of a respective duration. For example, a 20 ms processing cycle may be associated with a 20 ms processing frame size, while a 100 ms cycle may be associated with a 100 ms processing frame size. In other words, the audio playback thread 126 may be configured to support the plurality of processing frame sizes 116, each processing frame size of the plurality of processing frame sizes 116 being associated with a respective duration of the plurality of durations 112, for example, one-to-one association.

In an example, a first processing frame size among the plurality of processing frame sizes 116 may be associated with a first duration among the plurality of durations 112, while a second processing frame size among the plurality of processing frame sizes 116 may be associated with a second duration among the plurality of durations 112. Here, the second processing frame size may be different from the first processing frame size. For example, the second processing frame size may be greater or lesser than the first processing frame size.

In a scenario, if the audio playback thread 126 is configured with the processing cycle of the first duration, the audio playback thread 126 may be configured to process first audio content having the first processing frame size during the processing cycle. However, if the audio playback thread 126 is configured with the processing cycle of the second duration, the audio playback thread 126 may be configured to process second audio content having the second processing frame size during the processing cycle. In other words, if the processing cycle is set to the first duration, the audio playback thread 126 may periodically retrieve audio content having the first processing frame size from the first buffer memory 124, whereas if the processing cycle is set to the second duration, the audio playback thread 126 may periodically retrieve audio content having the second processing frame size from the second buffer memory 128, for processing and rendering.

In many aspects, the processor(s) 104 may be individually or collectively configured to set or reset the processing cycle of the audio playback thread 126 based on the operating parameter 118. The operating parameter 118 may refer to a contextual condition or a runtime condition associated with the device 102. The operating parameter 118 may be obtained from device-level metrics, usage scenarios, or user preferences. Examples of the operating parameter 118 may include a state of charge (SoC) of the power source 138, real-time network conditions (such as bandwidth or stability), audio content type (e.g., speech, music, or ambient sounds), playback modes (e.g., power-saving mode, high-performance mode), a device thermal state, or the like.

In many aspects, the operating parameter 118 may be evaluated or categorized into one of the plurality of categories 114. Each category of the plurality of categories 114 may represent a defined range or state of a particular operating parameter. For example, the SoC (e.g., the operating parameter 118) based on a current value or state may be mapped into the plurality of categories 114 such as low (0-30%), medium (31-70%), and high (71-100%). Similarly, network condition (e.g., the operating parameter 118) may be mapped into the plurality of categories 114 such as stable or unstable. Likewise, playback mode (e.g., the operating parameter 118) may be categorized into the plurality of categories 114 such as performance or power-efficiency. Likewise, device temperature (e.g., the operating parameter 118) may be mapped into the plurality of categories 114 such as normal, elevated, or critical.

In various aspects, the plurality of durations 112 may be associated with the plurality of categories 114, respectively, for example, one-to-one association. Thus, these plurality of categories 114 may provide a decision space for the processor(s) 104 to determine appropriate runtime configurations, such as selecting a suitable duration for the processing cycle for the audio playback thread 126, based on the operating parameter 118.

In many aspects, the processor(s) 104 may be individually or collectively configured to set the processing cycle of the audio playback thread 126 to the first duration of the plurality of durations 112 based on the operating parameter 118 associated with the device 102 being within a first category of the plurality of categories 114. The processor(s) 104 may be individually or collectively configured to detect a change in the operating parameter 118 such that the changed operating parameter 118 is within a second category of the plurality of categories 114. Based on the changed operating parameter 118 now being within the second category (which is different from the first category), the processor(s) 104 may be individually or collectively configured to reset the processing cycle to the second duration of the plurality of durations 112. In an example, the second duration can be longer or shorter than the first duration.

Such integration of adaptive processing cycles in the audio playback thread 126 may allow for a balance between latency and power consumption or other operating conditions. For example, as the processing cycle duration increases, the residual time the audio playback thread spends in the sleep state also increases, thereby enabling multiple power-saving configurations based on different processing cycle durations. By dynamically resetting the duration of the processing cycle based on changes in the operating parameter 118, the device 102 can optimize for low power usage without compromising the responsiveness for high-quality audio playback.

In an example, the operating parameter 118 can be SoC of the device 102 and the first and second categories may correspond to distinct SoC ranges (e.g., 0%-30%, 31%-70%, 71%-100%, or the like) in which the overall SoC capacity of the device 102 is split. In such a scenario if the SoC is in a high SoC range (e.g., 71%-100%), the processing cycle of the audio playback thread 126 can be set to the lowest duration to minimize latency. If the SoC changes and shifts to a medium SoC range (e.g., 31% 70%), the processing cycle of the audio playback thread 126 can be reset to a medium duration to reduce power consumption. If the SoC changes and shifts to a low SoC range (e.g., 0%-30%), the processing cycle of the audio playback thread 126 can be reset to the highest duration to minimize power consumption.

In further examples, the operating parameter 118 can be the real-time network conditions when the device 102 is streaming audio, for example, from the streaming service 134, and the first and second categories may correspond to stable and unstable connections, respectively. If the real-time network conditions are stable (e.g., high-speed internet connectivity), the processing cycle of the audio playback thread 126 can be set to the lowest duration to enable low-latency playback. If the real-time network conditions change and shift to unstable (e.g., poor connectivity), the processing cycle of the audio playback thread 126 can be reset to the highest duration. Allowing for additional buffering to reduce playback interruptions and reduce the frequency of thread activity of the audio playback thread 126, thereby conserving power.

In more examples, the operating parameter 118 can be a type of audio content being played, and the first and second categories may correspond to content with high or low complexity, respectively. If the audio content is complex (e.g., high-fidelity music tracks with rich dynamic range), the processing cycle of the audio playback thread 126 can be set to the lowest duration to enable precise synchronization and audio quality. If the audio content being played changes and shifts to simpler content (e.g., spoken-word content such as podcasts or audiobooks), the processing cycle of the audio playback thread 126 can be reset to a longer duration, thereby enabling reduced power consumption.

In additional examples, the operating parameter 118 can be a current playback mode, and the first and second categories may correspond to a performance mode and a power-saving mode, respectively. If the current playback mode is the performance mode, the processing cycle of the audio playback thread 126 can be set to the lowest duration to minimize latency and deliver a highly responsive audio playback experience. Alternatively, if the current playback mode changes to the power-saving mode, the processing cycle of the audio playback thread 126 can be reset to the highest duration to reduce power consumption.

In further examples, the operating parameter 118 can be a device temperature representing the thermal state of the device 102, and the first and second categories may correspond to a normal temperature range and an elevated or critical temperature range, respectively. If the device temperature is within the normal range (e.g., below 40° C.), the processing cycle of the audio playback thread 126 can be set to a lower duration to maintain performance and minimize latency. However, if the temperature changes and shifts to an elevated or critical range (e.g., exceeding 40° C. or 55° C.), the processing cycle of the audio playback thread 126 can be reset to a longer duration. Such adjustment in the duration of the processing cycle may reduce the frequency of thread wakeups and processor activity, thereby contributing to thermal regulation and preventing further heat buildup in thermally constrained conditions.

It will be apparent to a person of skill in the art that the examples of the operating parameter 118 described above are not an exhaustive list but are illustrative examples. Additional or alternate operating parameters may be used by the processor(s) 104 without deviating from the scope of the disclosure. For example, the operating parameter 118 may include a system-level concurrency indicator, such as a measure of active thread count, CPU utilization, or processor load at the time of audio playback. If thread concurrency is within a first range, the audio playback thread 126 may operate with a shorter processing cycle to improve responsiveness. Conversely, under high system concurrency, for example, within a second range, the processing cycle may be extended to reduce CPU contention with extended sleep state duration, without compromising on audio playback continuity.

In many aspects, as the processing cycle of the application thread 122 is configured to be the order of magnitude greater, such as 10 times, 20 times, or more, than the processing cycle of the audio playback thread 126, a greater temporal decoupling between the application thread 122 and the audio playback thread 126 is achieved. This decoupling enables the application thread 122 to buffer larger segments of audio data (e.g., 1 second, 2 seconds, or the like), enabling the audio playback thread 126 to operate with adaptive processing cycles (e.g., 20 ms, 50 ms, 100 ms) based on the operating parameter 118, without being bottlenecked by audio data supply rate of the application thread 122.

In many aspects, the terms “audio media”, “audio data”, and “audio content” may be used to refer to distinct units within an audio playback pipeline. Audio media may refer to a complete playback asset, such as an entire song, podcast episode, or audiobook file. The audio media may represent a full duration and structure of an audio or multimedia material intended for playback. Within each processing cycle of the application thread 122, a segment of the audio media is obtained, which is referred to as audio data. Thus, audio data may represent a portion of the audio media (for example, in a compressed or encoded format such as Advanced Audio Coding “AAC”, MPEG-1 Audio Layer III “MP3” or more such formats) that is obtained and buffered or stored by the application thread 122 for further processing. In turn, the audio playback thread 126 may retrieve smaller portions or chunks from the buffered audio data during corresponding processing cycles. These smaller portions or chunks may be referred to as audio content, and represent the units of audio that are processed and rendered in each processing cycle of the audio playback thread 126. For example, an audio media file may represent a 3-minute song. During each 1-second processing cycle of the application thread 122, a 1000 ms chunk of compressed audio data can be obtained from the audio media and stored in the first buffer memory 124 by the application thread 122. The audio playback thread 126, operating on a shorter processing cycle (e.g., 50 ms) than the application thread 122, may retrieve and decode 50 ms audio segments, referred to as audio content, from the buffered audio data in the first buffer memory 124 for playback.

In an example scenario, the device 102 may receive an audio playback request from a user. For example, the processor(s) 104 may be individually or collectively configured to receive an input signal to render an audio media (e.g., the on-device audio media 120 or the streaming audio media 136). The input signal may be received via one or more input devices associated with the device 102. In an aspect, the processor(s) 104 may be communicatively coupled to the input devices to receive the input signal indicative of rendering the audio media. Examples of the input devices may include, but are not limited to, a touch screen, a keyboard, a mouse, a display device, or a microphone.

Based on the received input signal, the processor(s) 104 may be individually or collectively configured to launch the application thread 122 and the audio playback thread 126. Upon launch, the application thread 122 may enter the active state. In the active state, the application thread 122 may obtain audio data associated with the audio media and write the audio data to the first buffer memory 124. If, in a non-limiting example, the application thread 122 has the processing cycle of one second, the application thread 122 may obtain and store the audio data of one second. Upon the storage of the obtained audio data in the first buffer memory 124, the application thread 122 may transition to the sleep state for the remainder time of the processing cycle. Thus, in an example, if the application thread 122 takes 20 ms to obtain and store the audio data in the first buffer memory 124, the application thread 122 may remain in the sleep state for 980 ms until the next processing cycle starts.

In some aspects, at the time of launching the audio playback thread 126, the processor(s) 104 may be individually or collectively configured to obtain the operating parameter 118. The processor(s) 104 may then set the processing cycle of the audio playback thread 126 to one of the plurality of durations 112 associated with a category of the plurality of categories 114 in which the obtained operating parameter 118 falls. In an example, the operating parameter 118 may be within the first category of the plurality of categories 114, and the first category may be associated with the first duration among the plurality of durations 112. As a result, the audio playback thread 126 at the launch may have the processing cycle set to the first duration based on the obtained operating parameter 118.

Based on the processing cycle being set to the first duration, the audio playback thread 126 may transition to the active state at the start of the processing cycle. In the active state, the audio playback thread 126 may retrieve audio content having the first processing frame size from the first buffer memory 124, process the retrieved audio content faster-than-real-time, and optionally store the processed audio content in the second buffer memory 128. Subsequently, upon a completion of the processing, the audio playback thread 126 may enter the sleep state for a residual time of the processing cycle.

Continuing the above example scenario, while the audio playback is in progress, the processor(s) 104 may detect a change in the operating parameter 118. For example, the operating parameter 118 may shift from the first category to the second category. In an example, the second category may be associated with the second duration among the plurality of durations 112. Thus, the processor(s) 104 may reset (e.g., modify, update, or reconfigure) the processing cycle of the audio playback thread 126 to the second duration. In other words, the setting of the processing cycle and the resetting of the processing cycle of the audio playback thread 126 are based on the obtained operating parameter 118.

Based on the processing cycle being reset to the second duration, the audio playback thread 126 may now periodically transition between the active state to process audio content of the second processing frame size and the sleep state upon the completion of the processing. Depending upon whether the second duration is greater than or less than the first duration, the time the audio playback thread 126 spends in the sleep state may also be correspondingly longer or shorter with the reset processing cycle.

In some aspects, a count of supported processing cycle durations (e.g., the plurality of durations 112) and duration values (e.g., 25 ms, 30 ms, 50 ms, etc.) may be configurable. Such configuration can be defined through user input, application-level software settings, firmware parameters, or over-the-air (OTA) updates. In many implementations, the plurality of durations 112 can be configured dynamically by a machine learning model or adaptive control logic based on usage patterns or historical device behavior. Thus, providing the flexibility in how these processing cycle durations are defined and updated.

FIG. 2A is a diagram of an example scenario 200A that illustrates various operations of the application thread 122 across a time axis, in accordance with certain aspects of the present disclosure. FIG. 2A is described in conjunction with FIG. 1. The example scenario 200A depicts the operation of the application thread 122 during multiple processing cycles, for example, processing cycles 202A and 202B, each having a duration T1. The application thread 122 may be configured to access the first buffer memory 124, which may be implemented as a circular buffer shared with the audio playback thread 126 shown in FIG. 1.

At the start of the processing cycle 202A, the application thread 122 may transition to an active state 204 for a duration T2 to perform data acquisition and storage operations. During the active state 204 of the processing cycle 202A, the application thread 122 may obtain first audio data 208A of an audio media, for example, from the on-device audio media 120 or the streaming service 134, and store the obtained first audio data 208A in the first buffer memory 124.

In various aspects, the first buffer memory 124 may include a tail marker 210 that corresponds to an insertion point for the application thread 122 to store obtained audio data (e.g., the obtained first audio data 208A) in the first buffer memory 124. As the first audio data 208A is stored in the first buffer memory 124, the tail marker 210 dynamically advances to an end of the stored first audio data 208A. In FIG. 2A, this new position of the tail marker is shown as “tail marker 210′”, which is at the end of the stored first audio data 208A. Upon completing the data storage, the application thread 122 may transition to a sleep state 206 for a remainder of the processing cycle (e.g., duration T3), until the start of the next processing cycle.

At the beginning of the next processing cycle 202B, the application thread 122 again transitions to the active state 204 for the duration T2, obtains second audio data 208B of the audio media, and stores the second audio data 208B at the insertion point marked by the updated tail marker 210′. Following the storage, the tail marker 210′ further advances to a new position at an end of the stored second audio data 208B. In FIG. 2A, this new position of the tail marker is shown as “tail marker 210″”, which is at the end of the stored second audio data 208B. The application thread 122 then returns to the sleep state 206 for the remaining duration of the processing cycle 202B (e.g., T3).

The illustration of the sleep state 206 being longer than the active state 204 in FIG. 2A is merely one example. In different implementations, the duration of the sleep state 206 may be shorter than or equal to that of the active state 204, depending on the configuration of the processing cycle of the application thread 122.

Though FIG. 2A illustrates the first buffer memory 124 as a circular buffer, the scope of the present disclosure is not limited to this implementation. In various additional aspects, the first buffer memory 124 may be implemented using different data structures or memory management techniques, such as a linear ring buffer, a double-buffering scheme, a first-in-first-out (FIFO) queue, or a dynamically allocated memory region with pointer-based indexing, without deviating from the scope of the disclosure.

FIG. 2B is a diagram of an example scenario 200B that illustrates various operations of the audio playback thread 126 across a time axis, in accordance with certain aspects of the present disclosure. FIG. 2B is described in conjunction with FIG. 1, and FIG. 2A. The example scenario 200B depicts the operation of the audio playback thread 126 during multiple processing cycles, such as the processing cycles 212A and 212B, each having the same duration T4. The audio playback thread 126 may access the first buffer memory 124, which may be implemented as a circular buffer shared with the application thread 122. In various aspects, the first buffer memory 124 may include a head marker 218 and the tail marker 210″.

At the start of the processing cycle 212A, the audio playback thread 126 may transition to an active state 214 for a duration T5 (e.g., the first duration of the plurality of durations 112). During the active state 214, the audio playback thread 126 may obtain audio content 220 having the first processing frame size from the first buffer memory 124 and process the audio content 220. In various aspects, the audio playback thread 126 may obtain the audio content 220 from stored audio data in the first buffer memory 124 based on the head marker 218. In an example, the head marker 218 may indicate a current read position for the audio playback thread 126. As the audio content 220 is read and processed, the head marker 218 dynamically advances to an end of the obtained audio content 220. In FIG. 2B, this new position of the head marker is shown as “head marker 218′”, which is at the end of the obtained audio content 220 and marks an updated read position for the audio playback thread 126.

Upon completion of the audio content processing, for example, faster-than-real-time, the audio playback thread 126 may transition to a sleep state 216 for a residual time of the processing cycle 212A, represented by T6, until the start of the next processing cycle. In this example, the total duration T4 of the processing cycle 212A is a sum of the durations of the active state 214 and the sleep state 216.

At the beginning of the processing cycle 212B, the audio playback thread 126 again transitions to the active state 214 for the duration T5 and obtains audio content 222 from the first buffer memory 124. The head marker 218′ dynamically advances to a new position after the audio content 222 is read and processed, indicating the updated read position in the first buffer memory 124. In FIG. 2B, this new position of the head marker is shown as “head marker 218″”, which is at the end of the audio content 222. The audio playback thread 126 then transitions to the sleep state 216 for the remaining duration T6 of the processing cycle 212B.

The illustration of the sleep state 216 being shorter than the active state 214 in FIG. 2B is merely one example. The duration of the sleep state can change, example, become greater than or equal to that of the active state, depending on the resetting of the duration of the processing cycle.

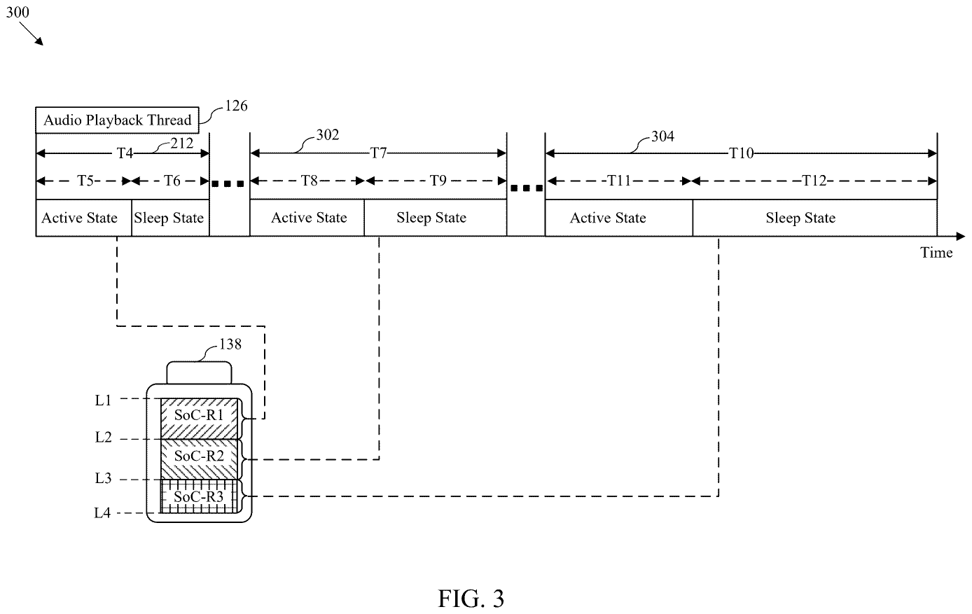

FIG. 3 is a diagram of an example scenario 300 that illustrates various operations of the audio playback thread 126 across multiple processing cycles, where cycle durations are adapted based on operating parameter conditions such as SoC, in accordance with certain aspects of the present disclosure. FIG. 3 is described in conjunction with FIGS. 1, 2A, and 2B.

As described in the foregoing description of FIGS. 1, 2A, 2B, the audio playback thread 126 may access the first buffer memory 124 (as shown in FIGS. 1, 2A, 2B) and periodically transition between an active state and a sleep state within a series of processing cycles. The duration of each processing cycle may be determined based on a value or a state of the operating parameter 118 as shown in FIG. 1.

In the example scenario 300, the operating parameter 118 is assumed to be the SoC of the power source 138. The SoC capacity of the power source 138 may be split into a plurality of SoC ranges such as a first SoC range SoC-R1, a second SoC range SoC-R2, and a third SoC range SoC-R3, which correspond to SoC levels between L1-L2, L2-L3, and L3-L4, respectively. In other words, the operating parameter 118 corresponds to the SoC and the plurality of categories 114 corresponds to the plurality of SoC ranges, respectively. In an example, the first category described in the foregoing description of FIG. 1 may correspond to the first SoC range SoC-R1, the second category described in the foregoing description of FIG. 1 may correspond to the second SoC range SoC-R2, and a third category of the plurality of categories 114 may correspond to the third SoC range SoC-R3. The SoC of the power source 138 may decrease over time due to continued usage, and the processing cycle of the audio playback thread 126 is adapted accordingly.

Initially, the SoC of the power source 138 may be within the first SoC range SoC-R1 (between L1 and L2) and the audio playback thread 126 may be configured to operate in a first processing cycle 212 (e.g., any of the processing cycles 212A and 212B of FIG. 2B) with the first duration T4. Thus, at the start of the first processing cycle 212, the audio playback thread 126 may transition to an active state for the duration T5 to process first audio content, and upon completion, enter a sleep state for a remaining duration T6 of the first processing cycle 212.

As the SoC of the power source 138 falls into the second SoC range SoC-R2 (between L2 and L3), the audio playback thread 126 may be re-configured to operate in a second processing cycle 302 with an increased duration (e.g., a second duration T7). During the second processing cycle 302, the audio playback thread 126 may transition to the active state for a longer duration T8 and enter the sleep state for a duration T9. The increased duration of the second processing cycle 302 may allow the audio playback thread 126 to handle a larger processing frame size during the active state, while also increasing the sleep duration relative to the first processing cycle 212, thereby reducing wakeups and conserving power.

With continued use, the SoC of the power source 138 may drop further into the third SoC range SoC-R3 (between L3 and L4). In such a scenario, the audio playback thread 126 may be re-configured to operate in a third processing cycle 304, having a longer duration (e.g., a third duration T10) than the first duration T4 and the second duration T7. The audio playback thread 126 may transition to the active state for a duration T11, process a further enlarged processing frame size, and return to the sleep state for the remaining duration T12. As the processing cycle duration of the audio playback thread 126 increases progressively from T4 to T7 to T10, time spent in the sleep state may be increased.

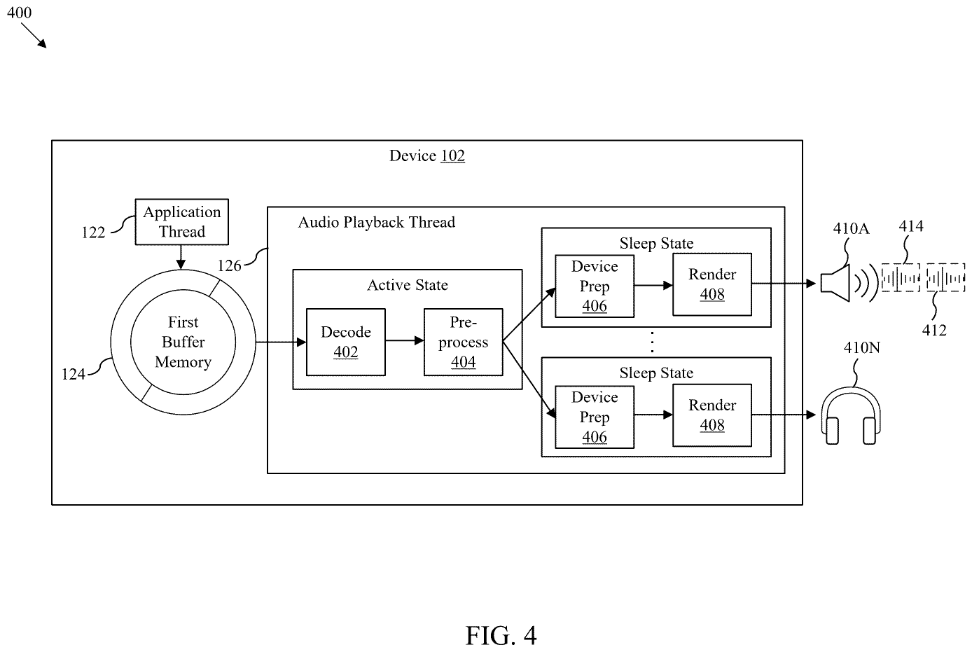

FIG. 4 is a diagram 400 that illustrates various operations of the device 102 that supports audio playback with adaptive processing cycles, in accordance with certain aspects of the present disclosure. FIG. 4 is described in conjunction with FIG. 1-3. As shown in FIG. 4, the device 102 may include the application thread 122, the first buffer memory 124, and the audio playback thread 126. As shown, the first buffer memory 124 is accessible by the application thread 122 and the audio playback thread 126.

As described in the foregoing description of FIG. 1-3, the audio playback thread 126 may access the first buffer memory 124 and periodically transition between an active state and a sleep state within a series of processing cycles to perform various operations related to audio processing and rendering. The duration of each processing cycle may be determined (e.g., set or reset) based on a value or a state of the operating parameter 118 as shown in FIG. 1.

During the active state, the audio playback thread 126 may be configured to perform one or more processing operations for preparing audio content for playback. For example, the audio playback thread 126 may execute a decode operation 402 and a pre-process operation 404 in the active state. In an example, the decode operation 402 may include reading audio content, having a specific processing frame size as per processing cycle duration, from the first buffer memory 124 and decoding the audio content into audio packets. The decode operation 402 may be dependent on a format of the audio content.

Following the decode operation 402, the audio playback thread 126 may execute the pre-process operation 404, where decoded audio packets may be conditioned for rendering. In an example, the pre-process operation 404 may include sampling rate conversion, channel mapping (e.g., stereo to mono), audio normalization, gain control, or applying equalization or effects, or the like.

Upon a completion the one or more processing operations (e.g., the decode operation 402 and the pre-process operation 404), the audio playback thread 126 may enter the sleep state. In the sleep state, the audio playback thread 126 may execute one or more rendering-related operations to maintain audio continuity. In the sleep state, the audio playback thread 126 may execute a device preparation operation 406 (indicated as “device-prep” in FIG. 4), where an audio output device (e.g., a speaker 410A) is prepared to receive processed audio content. The device preparation operation 406 may involve buffer alignment, channel initialization, or clock configuration. After the device preparation operation 406, the audio playback thread 126 may perform a render operation 408, during which the processed audio content is transmitted to the audio output device for playback of audio media.

In various aspects, the audio playback thread 126 may execute the rendering-related operations (e.g., the device preparation operation 406 and the render operation 408) for multiple audio output devices. For example, as shown in FIG. 4, the audio playback thread 126 executes the rendering-related operations (e.g., the device preparation operation 406 and the render operation 408) for ‘N’ audio output devices such as the speaker 410A and headphones 410N.

In various aspects, the speaker 410A (and the headphones 410N) may be configured to output an audio signal based on the processed audio content delivered by the audio playback thread 126. In one example, the speaker 410A may output the audio signal based on the processing cycle of the audio playback thread 126 being set to the first duration (as described in the foregoing description of FIG. 1-3). In a scenario where the processing cycle of the audio playback thread 126 is reset to the second duration, as described in the foregoing description of FIG. 1-3, the speaker 410A (and the headphones 410N) may update the output of the audio signal accordingly. For example, during a power-saving operation when the processing cycle is reset to a longer duration, the processed audio content may be delivered less frequently but with larger data sizes to the speaker 410A (and the headphones 410N). In such a scenario, the speaker 410A (and the headphones 410N) may adapt to the varying arrival rates and sizes of audio content and update the output of the audio signal accordingly. In FIG. 4, a first portion 412 of the audio signal, outputted prior to the update, and a second portion 414 of the audio signal, outputted after the update, are illustrated.

Thus, the sleep state of the audio playback thread 126 may refer to a low-activity operating condition in which the audio playback thread 126 suspends active processing tasks, such as decoding or pre-processing. In the sleep state, the audio playback thread 126 may execute from, for example, a low-power island, a subsystem within the processor(s) 104 configured to remain operational with minimal energy consumption.

Additional examples of audio output devices may include wearable devices such as smart watches, XR glasses, Headsets, ear phones, IoT devices, or the like. Such power sensitive IoT devices and wearables may be benefitted by implementation of adaptive processing cycles with faster-than-real-time processing to enhance energy efficiency, thereby allowing prolonged battery life.

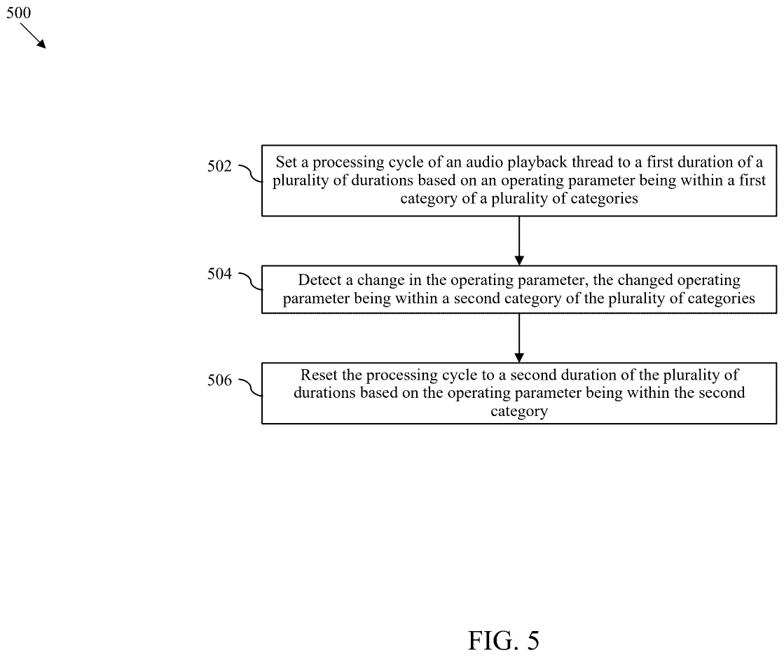

FIG. 5 is a high-level flowchart that illustrates a method (e.g., a process) for dynamically adapting a processing cycle of an audio playback thread, in accordance with certain aspects of the present disclosure. In many examples, the method may be executed at the device 102 described in the foregoing description of FIG. 1-4. Referring to FIG. 5, there is shown a flowchart 500 that illustrates example operations 502 through 506 for dynamically adapting a processing cycle of the audio playback thread 126 described in the foregoing description of FIG. 1-4. In a non-limiting example, the flowchart 500 is explained with reference to the device 102 of FIG. 1-4.

At 502, a processing cycle of an audio playback thread may be set to a first duration of a plurality of durations. For example, the processor(s) 104 may be individually or collectively configured to set the processing cycle of the audio playback thread 126 to the first duration of the plurality of durations 112 based on the operating parameter 118 being within the first category of the plurality of categories 114 as described in the foregoing description of FIG. 1-4.

At 504, a change in the operating parameter 118 may be detected. For example, the processor(s) 104 may be individually or collectively configured to detect the change in the operating parameter 118. The changed operating parameter 118 may fall within the second category of the plurality of categories 114. Details associated with change in the operating parameter 118, are provided, for example, in conjunction with FIG. 1-4.

At 506, the processing cycle may be reset to a second duration of the plurality of durations. For example, the processor(s) 104 may be individually or collectively configured to reset the processing cycle to the second duration of the plurality of durations 112 based on the operating parameter 118 being within the second category. Details associated with the resetting of the processing cycle are provided, for example, in conjunction with FIG. 1-4.

Such integration of adaptive processing cycles in the audio playback thread 126 allows for a balance between latency and power consumption. By dynamically resetting the processing cycle duration based on changes in the operating parameter 118, the device 102 can optimize for low power usage without compromising the responsiveness for high-quality audio playback. Additionally, in a case where the device 102 is battery-powered, such power consumption optimization can improve battery life. Thus, the overall playback time of the device 102 can be extended. Such enhancement may allow users to enjoy extended usage periods without the need for frequent recharging, making the device 102 more reliable and convenient for prolonged use.

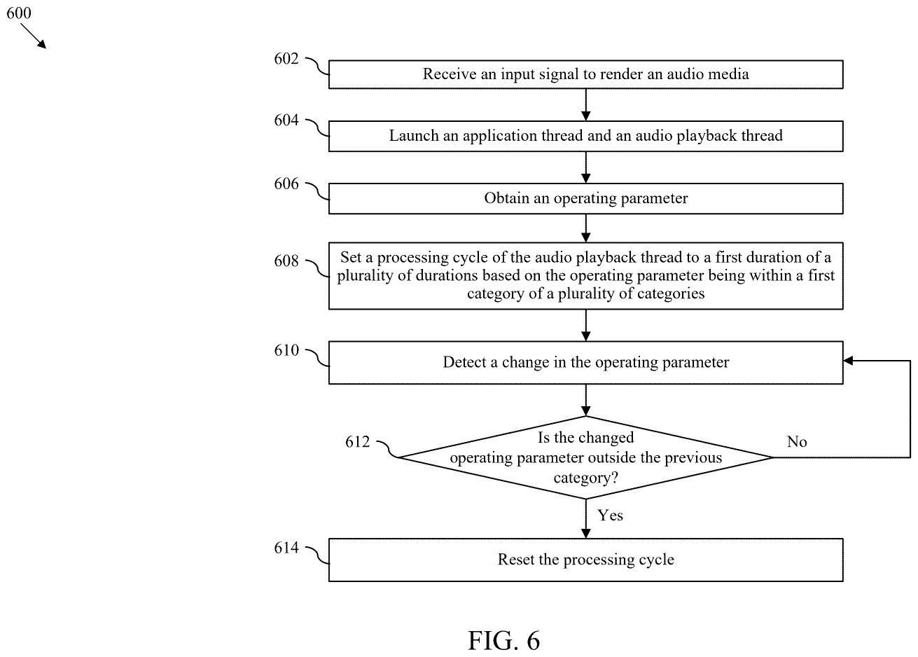

FIG. 6 is a detailed flowchart that illustrates a method (e.g., a process) for dynamically adapting a processing cycle of an audio playback thread, in accordance with certain aspects of the present disclosure. FIG. 6 is described in conjunction with FIGS. 1-4. Referring to FIG. 6, there is shown a flowchart 600 that illustrates example operations 602 through 614 for dynamically adapting a processing cycle of the audio playback thread 126 described in the foregoing description of FIG. 1-4.

At 602, an input signal may be received to render an audio media. For example, the processor(s) 104 may be individually or collectively configured to receive the input signal to render the audio media as described in the foregoing description of FIG. 1. In non-limiting examples, the input signal may correspond to a touch signal, a voice command, or a request via an application programming interfaces. For example, the input signal may be received via a touch screen input, a button press, or a voice command to render the audio media. Further, the audio media be locally stored audio media on the device 102 or audio media streamed on the device 102 from a remote media source over a communication network, e.g., Internet.

At 604, an application thread and an audio playback thread may be launched. For example, the processor(s) 104 may be individually or collectively configured to launch the application thread 122 and the audio playback thread 126 based on the received input signal as described in the foregoing description of FIG. 1-4.

At 606, an operating parameter may be obtained. For example, the processor(s) 104 may be individually or collectively configured to obtain the operating parameter 118. In an aspect, the processor(s) 104 may be individually or collectively configured to obtain the operating parameter 118 through the application thread 122 associated with the audio playback thread 126. For example, the application thread 122 may interface with higher-level media or device services and can obtain a real-time or near real-time status of the operating parameter 118 and store in the memory 108. The application thread 122 may include or invoke an application programming interface (API) to obtain the operating parameter 118. The API can be configured to perform periodic polling at defined time intervals or be triggered asynchronously by device events such as changes in SoC level, network state, or user interaction. The obtained operating parameter 118 may be communicated to the processor(s) 104. In further aspects, the processor(s) 104 may be individually or collectively configured to obtain the operating parameter 118 based on at least one of the real-time monitoring, the periodic sampling, or the trigger event. For example, real-time monitoring may involve continuously tracking status of the operating parameter 118 such as battery voltage, CPU temperature, network bandwidth, or the like through integrated sensors or firmware-level telemetry. In further examples, periodic sampling may include polling specific registers or system counters of the device 102 at fixed intervals to detect gradual changes in the status of the operating parameter 118 such as SoC or playback load. With periodic sampling of the operating parameter 118, the processor(s) 104 may detect the change in the operating parameter 118 over a time period. In more examples, a trigger event may include an interrupt or system signal, such as a low-battery warning, thermal threshold breach, or user-initiated mode change, which prompts the processor(s) 104 to obtain the operating parameter 118 from the memory 108.

At 608, a processing cycle of the audio playback thread may be set to a first duration of a plurality of durations based on the operating parameter being within a first category of a plurality of categories. For example, the processor(s) 104 may be individually or collectively configured to set the processing cycle of the audio playback thread 126 to the first duration of the plurality of durations 112 based on the operating parameter 118 being within the first category of the plurality of categories 114. In many aspects, the audio playback thread 126 at the launch may have the processing cycle set to the first duration of the plurality of durations 112. In many examples, the plurality of durations 112 may be associated with the plurality of categories 114, respectively. Thus, setting the processing cycle may be based on the association between the plurality of durations 112 and the plurality of categories 114, respectively. For example, if the first category, in which the operating parameter 118 falls, is associated with the first duration, the processor(s) 104 may set the processing cycle of the audio playback thread 126 to the first duration.

At 610, a change in the operating parameter may be detected. For example, the processor(s) 104 may be individually or collectively configured to detect the change in the operating parameter 118. The processor(s) 104 may re-obtain the operating parameter 118 after the processing cycle of the audio playback thread 126 is set to the first duration. If the latest status of the operating parameter 118 is different from the previous status of the operating parameter 118, the processor(s) 104 may detect the change in the operating parameter 118.

At 612, the processor(s) 104 may determine if the changed operating parameter 118 is outside the previous category. For example, the processor(s) 104 may determine if the changed operating parameter 118 is outside the first category. In an example, if at 612, the operating parameter 118 is determined to be within the previous category (for example, the first category), the control may pass to 610; however, if at 612, the changed operating parameter 118 is determined to be outside the previous category, control may pass to 614.

At 614, the processing cycle may be reset. For example, the processor(s) 104 may be individually or collectively configured to reset the processing cycle of the audio playback thread 126 based on the changed operating parameter 118 being outside the previous category. In an example, the processor(s) 104 may determine that the operating parameter 118 has shifted from the first category to the second category of the plurality of categories 114. In a scenario where the second category is associated with the second duration in the plurality of durations 112, the processor(s) 104 may reset the processing cycle to the second duration based on the operating parameter 118 being within the second category. Thus, the resetting of the processing cycle to the second duration may be based on the association between the plurality of durations 112 and the plurality of categories 114, respectively.

In various aspects, in a case where the second duration is greater than the first duration, a first power consumption associated with the audio playback thread 126 having the processing cycle set to the first duration may be higher than a second power consumption associated with the audio playback thread 126 having the processing cycle reset to the second duration. However, in a case where the first duration is greater than the second duration, the first power consumption associated with the audio playback thread 126 having the processing cycle set to the first duration is lower than the second power consumption associated with the audio playback thread 126 having the processing cycle reset to the second duration.

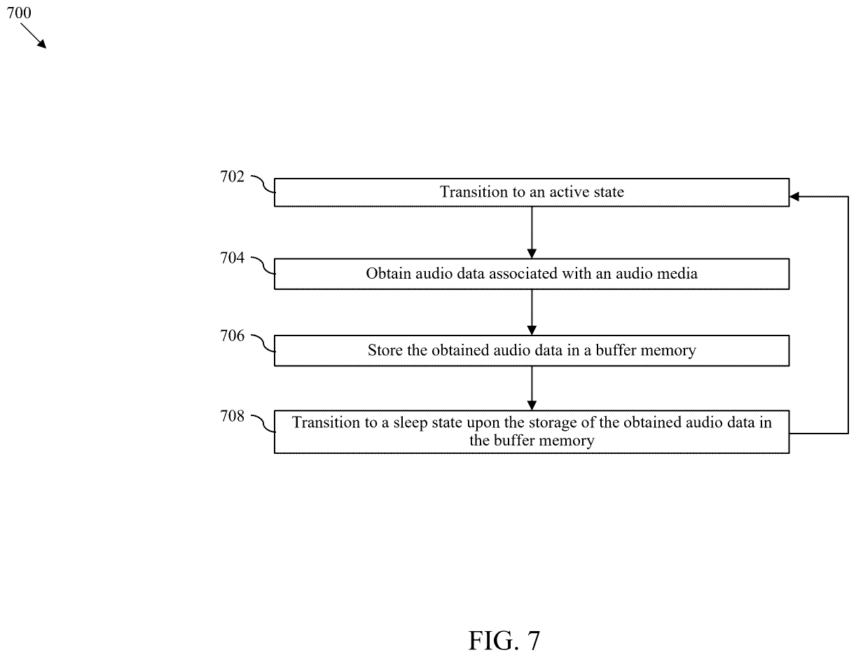

FIG. 7 is a high-level flowchart that illustrates a method (e.g., a process) executed at a device by an application thread, in accordance with certain aspects of the present disclosure. FIG. 7 is described in conjunction with FIG. 1-4. Referring to FIG. 7, there is shown a flowchart 700 that illustrates example operations 702 through 708 executed by the application thread 122 described in the foregoing description of FIGS. 1-4.

At 702, the application thread 122 may transition to an active state. For example, the application thread 122 may transition to the active state at start of corresponding processing cycle as described in the foregoing description of FIG. 1-4.

At 704, audio data associated with an audio media may be obtained. For example, the application thread 122 may be configured to obtain the audio data (such as the audio data 208A or 208B) associated with the audio media as described in the foregoing description of FIG. 1-4. The application thread 122 may obtain the audio data from the on-device audio media 120 or the streaming services 134.

At 706, the obtained audio data may be stored in a buffer memory. For example, the application thread 122 may be configured to store the obtained audio data in the first buffer memory 124. In an example, the application thread 122, in the active state, may store the obtained audio data in the first buffer memory 124 based on a tail marker in the first buffer memory 124.

At 708, the application thread 122 may transition to a sleep state upon the storage of the obtained audio data in the buffer memory. For example, the application thread 122 may be configured to transition to the sleep state once the obtained audio data is successfully stored in the first buffer memory. The application thread 122 may switch to the sleep state for a remaining portion of the processing cycle to conserve power, and the control may pass to 702 at the start of the next processing cycle.

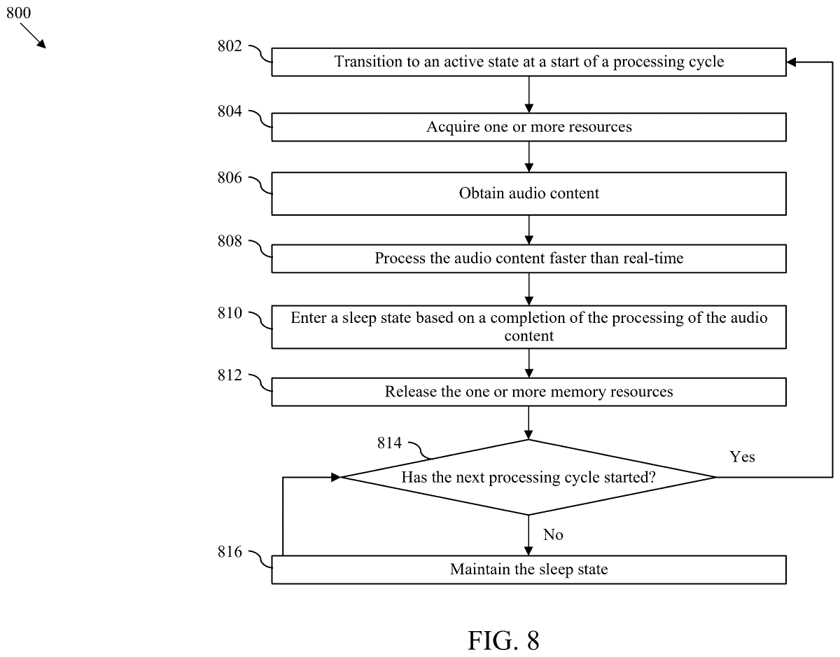

FIG. 8 is a detailed flowchart that illustrates a method (e.g., a process) executed at a device by an audio playback thread that supports a faster-than-real-time processing, in accordance with certain aspects of the present disclosure. FIG. 8 is described in conjunction with FIG. 1-4. Referring to FIG. 8, there is shown a flowchart 800 that illustrates example operations 802 through 816 executed by the audio playback thread 126 described in the foregoing description of FIG. 1-4.

At 802, the audio playback thread 126 may transition to an active state at a start of a processing cycle. In an example, the processing cycle may be set to the first duration. At 804, one or more resources may be acquired. For example, the audio playback thread 126 may be configured to acquire the one or more resources based on the transition of the audio playback thread 126 to the active state. The one or more resources comprise at least one of a memory bandwidth of the one or more memories (e.g., the memory 108) of the device 102 or a clocking resource of the device 102. For example, upon entering the active state, the audio playback thread 126 may vote for required resources such as the memory bandwidth and clock frequency for executing the decode operation 402 and the pre-process operation 404 as described in the foregoing description of FIG. 4. For example, when transitioning to the active state, the audio playback thread 126 may request a double data rate (DDR) bandwidth vote of 800 Megabytes per second (MBps) to access audio buffers (e.g., the first buffer memory 124 and the second buffer memory 128) from the memory 108 and a clock vote to scale processor frequency to 600 MHz for real-time decoding.

At 806, an audio content may be obtained. For example, the audio playback thread 126 may be configured to obtain the audio content. In many aspects, the audio playback thread 126 may be configured to obtain the audio content stored in the first buffer memory 124 corresponding to a duration set for the processing cycle of the audio playback thread 126.

At 808, the audio content may be processed faster-than-real-time. For example, the audio playback thread 126 may be configured to process the audio content faster-than-real-time in the active state. In many aspects, the duration of the processing cycle and the processing frame size may be same, for example, 20 ms. Therefore, in order for the audio playback thread 126 to enter the sleep state for at least a portion of the processing cycle, the audio playback thread 126 may process the obtained audio content in less time than the actual duration of the processing frame size.

At 810, the audio playback thread 126 may enter a sleep state based on a completion of the processing of the audio content. In many aspects, the audio playback thread 126 may enter the sleep state for a residual time of the processing cycle after the completion of the processing of the audio content.

At 812, the one or more memory resources may be released. For example, the audio playback thread 126 may be configured to release the one or more resources. In many aspects, the audio playback thread 126 may release the acquired memory bandwidth and clocking based on the transition to the sleep state. In an example, upon transitioning to the sleep state, the audio playback thread 126 may release the previously requested DDR bandwidth and clock votes, such as releasing the 800 MBps memory bandwidth request and allowing the processor frequency to scale down or scale up from 600 Megahertz (MHz). Thus, by allowing the audio playback thread 126 to enter the sleep state for the remainder of the processing cycle, as enabled by faster-than-real-time processing, the audio playback thread 126 can release the acquired resources when not in use and further contribute to power savings.

At 814, the audio playback thread 126 may determine whether the next processing cycle has started. In an aspect, if at 814, the audio playback thread 126 determines that the next processing cycle has not started, the control may pass to 816. At 816, the sleep state may be maintained. For example, the audio playback thread 126 may configured to maintain the sleep state until the next processing cycle starts. In many aspects, the audio playback thread 126 may maintain the sleep state to conserve power. However, if at 814, the audio playback thread 126 determines that the next processing cycle has started, control may pass to 802, where the audio playback thread 126 again transitions to the active state.

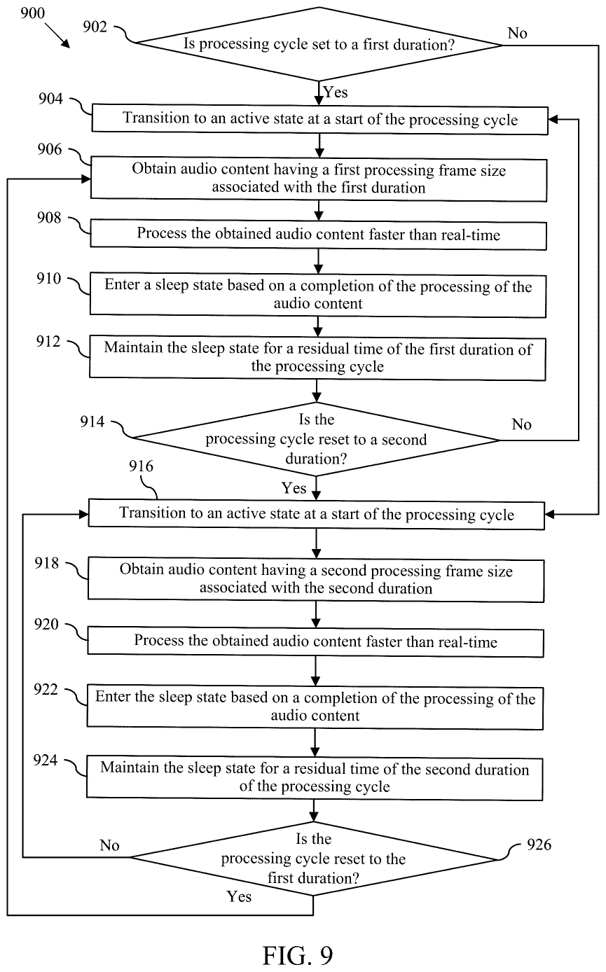

FIG. 9 is a detailed flowchart that illustrates a method (e.g., a process) executed at a device by an audio playback thread that supports an adaptive processing cycle with faster-than-real-time processing, in accordance with certain aspects of the present disclosure. FIG. 9 is described in conjunction with FIG. 1-4. Referring to FIG. 9, there is shown a flowchart 900 that illustrates example operations 902 through 926 executed by the audio playback thread 126 described in the foregoing description of FIG. 1-4.

At 902, the audio playback thread 126 may determine if the processing cycle is set to a first duration. In many aspects, the audio playback thread 126 at the launch has the processing cycle set to the first duration. If at 902, the audio playback thread 126 determines that the processing cycle is set to the first duration, control may pass to 904.

At 904, the audio playback thread 126 may transition to an active state at a start of the processing cycle. At 906, audio content may be obtained having a first processing frame size associated with the first duration. For example, the audio playback thread 126 may be configured to obtain the audio content (e.g., first audio content) having the first processing frame size associated with the first duration. In many aspects, the audio playback thread 126 may obtain the audio content from the first buffer memory 124. At 908, the obtained audio content may be processed faster-than-real-time. For example, the audio playback thread 126 may be configured to process the obtained audio content faster-than-real-time. At 910, the audio playback thread 126 may enter a sleep state based on a completion of the processing of the audio content. At 912, the sleep state may be maintained for a residual time of the first duration of the processing cycle. For example, the audio playback thread 126 may be configured to maintain the sleep state for the residual time of the first duration of the processing cycle.

At 914, the audio playback thread 126 may determine if the processing cycle is reset to a second duration. In an example, when the processing cycle is not reset to the second duration, the control may pass to 904, else the control may pass to 916. Further, if at 902, the audio playback thread 126 determines that the processing cycle is not set to the first duration but the second duration, control may pass to 916.

At 916, the audio playback thread 126 may transition to an active state at a start of the processing cycle. At 918, audio content may be obtained having a second processing frame size associated with the second duration. For example, the audio playback thread 126 may be configured to obtain the audio content stored in the first buffer memory 124 having the second processing frame size associated with the second duration. At 920, the obtained audio content may be processed faster-than-real-time. For example, the audio playback thread 126 may be configured to process the audio content faster-than-the-real-time in the active state.

At 922, the audio playback thread 126 may enter the sleep state based on a completion of the processing of the audio content. At 924, the sleep state may be maintained for a residual time of the second duration of the processing cycle. For example, the audio playback thread 126 may be configured to maintain the sleep state for the residual time of the second duration of the processing cycle.

At 926, the audio playback thread 126 may determine if the processing cycle is reset to the first duration. In an example, if the processing cycle is not reset to the first duration, the control may passed to 916, else the control may pass to 904.

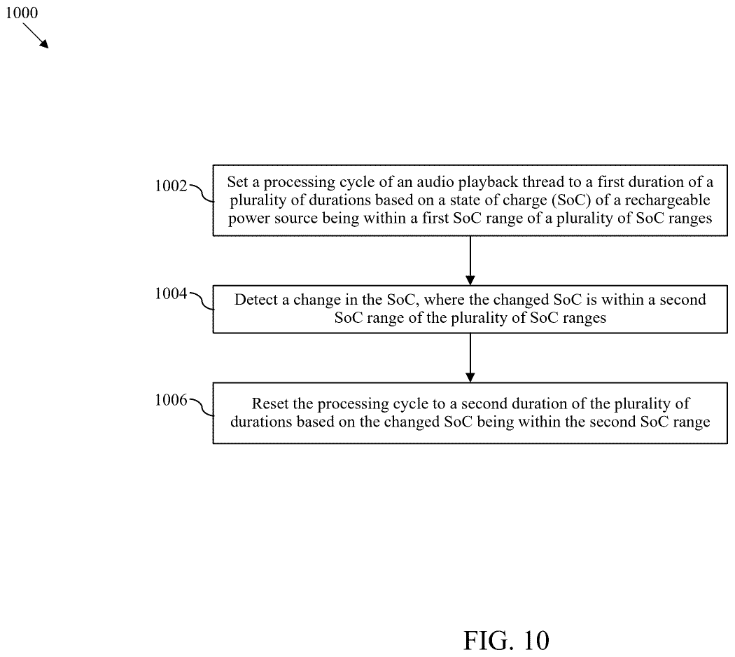

FIG. 10 is a high-level flowchart that illustrates a method (e.g., a process) for dynamically adapting a processing cycle of an audio playback thread based on an SoC associated with a device, in accordance with certain aspects of the present disclosure. In many examples, the method may be executed at the device 102 described in the foregoing description of FIG. 1-4. Referring to FIG. 10, there is shown a flowchart 1000 that illustrates example operations 1002 through 1006 for dynamically adapting a processing cycle of the audio playback thread 126 based on the SoC of the power source 138 (e.g., a rechargeable power source) described in the foregoing description of FIG. 1-4. In a non-limiting example, the flowchart 1000 is explained with reference to the device 102 of FIG. 1-4.

At 1002, a processing cycle of an audio playback thread may be set to a first duration of a plurality of durations based on an SoC of a rechargeable power source being within a first SoC range of a plurality of SoC ranges. For example, the processor(s) 104 may be individually or collectively configured to set the processing cycle of the audio playback thread 126 to the first duration of the plurality of durations 112 based on the SoC of the power source 138 being within the first SoC range (e.g., any of the SoC-R1, SoC-R2, or SoC-R3) of the plurality of SoC ranges as described in the foregoing description of FIG. 3. The SoC may correspond to an amount of charge available in the power source 138 before the power source 138 is fully discharged. In an example, the SoC may correspond to battery level of the power source 138. In more examples, the plurality of SoC ranges may be associated with the plurality of durations 112, respectively, as described at least in the foregoing description of FIGS. 1 and 3.

At 1004, a change in the SoC may be detected, where the changed SoC is within a second SoC range of the plurality of SoC ranges. For example, the processor(s) 104 may be individually or collectively configured to detect the change in the SoC. The changed SoC may be within the second SoC range (e.g., any of the SoC-R1, SoC-R2, or SoC-R3) of the plurality of SoC ranges. In an example, the SoC may change from the first category (e.g., the first SoC range SoC-R1) to the second category (say, the second SoC range SoC-R2).

At 1006, the processing cycle may be reset to a second duration of the plurality of durations based on the changed SoC being within the second SoC range. For example, the processor(s) 104 may be individually or collectively configured to reset the processing cycle to the second duration based on the changed SoC being within the second SoC range. In an example, the second duration may be associated with the second SoC range in the changed SoC falls.

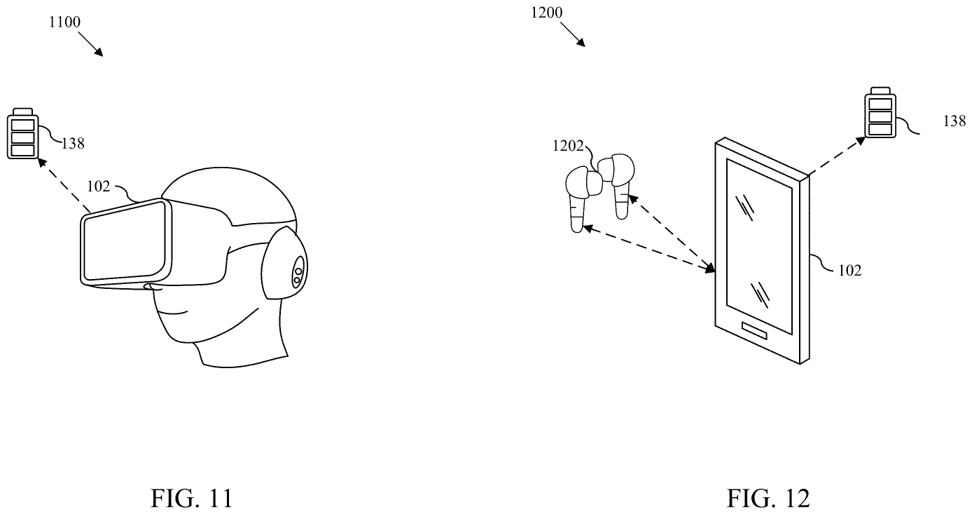

FIG. 11 is a diagram 1100 that illustrates a first example implementation of the device 102 that supports audio playback with adaptive processing cycles, in accordance with certain aspects of the present disclosure. FIG. 11 is described in conjunction with FIG. 1-10. In the first example implementation, the device 102 may correspond to an XR headset having the power source 138, which can be a rechargeable power source.

FIG. 12 is a diagram 1200 that illustrates a second example implementation of the device 102 that supports audio playback with adaptive processing cycles, in accordance with certain aspects of the present disclosure. FIG. 12 is described in conjunction with FIG. 1-10. In the second example implementation, the device 102 may correspond to a mobile device, such as a smartphone, a tablet, a phablet, having the power source 138, which can be a rechargeable power source. In such a scenario, the device 102 may include a display screen to display a video playback concurrently with the audio playback. Further, the device 102 may be communicatively coupled to wireless earbuds 1202, illustrated as a pair of in-ear earphones, to output an audio signal during the audio playback.

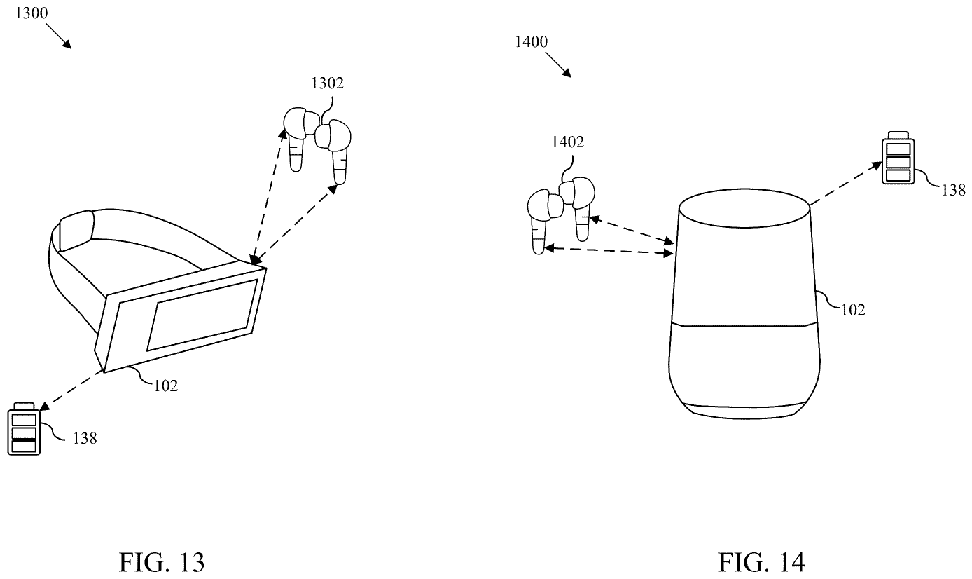

FIG. 13 is a diagram 1300 that illustrates a third example implementation of the device 102 that supports audio playback with adaptive processing cycles, in accordance with certain aspects of the present disclosure. FIG. 13 is described in conjunction with FIG. 1-10. In the third example implementation, the device 102 may correspond to a wearable electronic device, for example, a smart watch, having the power source 138, which can be a rechargeable power source. Further, the device 102 may be communicatively coupled to wireless earbuds 1302, illustrated as a pair of in-ear earphones, to output an audio signal during the audio playback.

FIG. 14 is a diagram 1400 that illustrates a fourth example implementation of the device 102 that supports audio playback with adaptive processing cycles, in accordance with certain aspects of the present disclosure. FIG. 14 is described in conjunction with FIG. 1-10. In the fourth example implementation, the device 102 may correspond to a voice-controlled entertainment device, having the power source 138. The device 102 may have wireless network connectivity and may be configured to execute an assistant operation. Further, the device 102 may be communicatively coupled to wireless earbuds 1402, illustrated as a pair of in-ear earphones, to output an audio signal during the audio playback.

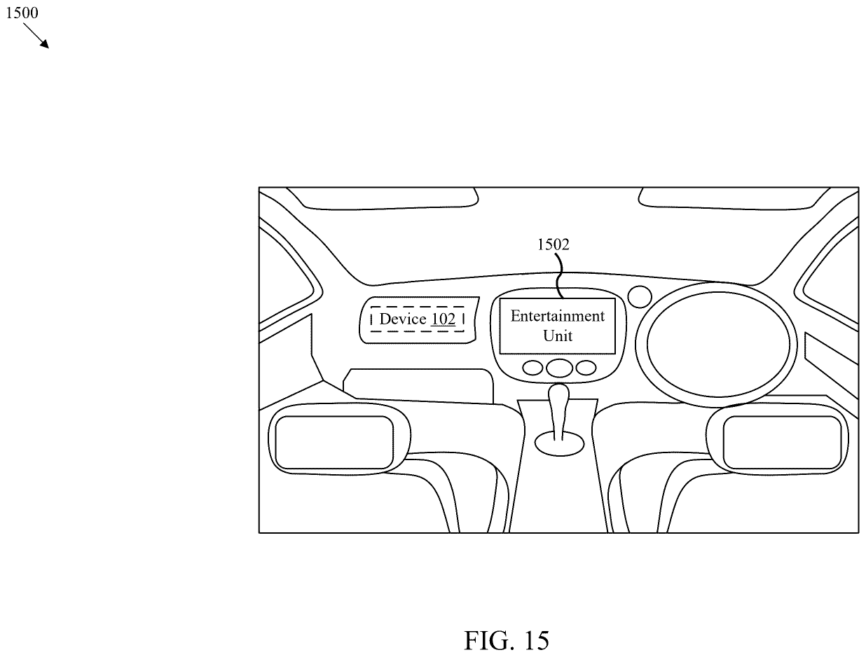

FIG. 15 is a diagram 1500 that illustrates a fifth example implementation of the device 102 that supports audio playback with adaptive processing cycles, in accordance with certain aspects of the present disclosure. FIG. 15 is described in conjunction with FIG. 1-10. In the fifth example implementation, the device 102 may correspond to, or be integrated within, a vehicle 1500, illustrated as a car. In an example, the device 102 may correspond to, or be incorporated within, an entertainment unit 1502 of the vehicle 1500. The entertainment unit 1502 may thus utilize the device 102 for audio playback with adaptive processing cycle.

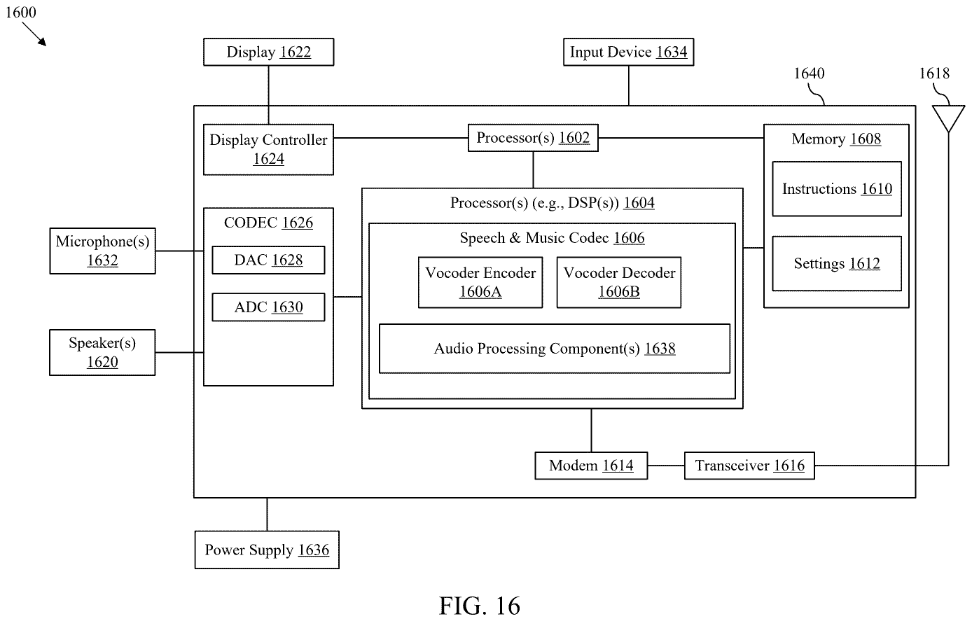

FIG. 16 is a block diagram that illustrates a device 1600 operable to support audio playback with adaptive processing cycles, in accordance with certain aspects of the present disclosure. In various implementations, the device 1600 may have more or fewer components than illustrated in FIG. 16. In an illustrative implementation, the device 1600 may correspond to the device 102. In an illustrative implementation, the device 1600 may perform one or more operations described with reference to FIG. 1-15.

In a particular implementation, the device 1600 includes a processor(s) 1602 (e.g., a CPU). The device 1600 may include one or more additional processor(s) 1604 (e.g., one or more DSPs). In a particular aspect, the processor(s) 104 of FIG. 1 may be included in or may correspond to the processor(s) 1602 or the processor(s) 1604. The processor(s) 1604 may include a speech and music coder-decoder (CODEC) 1606 that includes a voice coder (“Vocoder”) encoder 1606A and a vocoder decoder 1606B, or a combination thereof. The speech and music CODEC 1606 may further include audio processing component(s) 1638. In an example, the audio processing component(s) 1638 may correspond to one or more hardware blocks configured to perform real-time audio operations such as decoding, format conversion, or signal conditioning. These components may include hardware accelerator blocks or embedded microcontrollers, which can be invoked by the audio playback thread 126 during the active state for audio decoding and pre-processing tasks.

The device 1600 may include a memory 1608 and a CODEC 1626. The memory 1608 may include instructions 1610 that are executable by the processor(s) 1602 or the processor(s) (s) 1604 to implement functionality described with reference to the processor(s) 104. The memory 1608 may also include settings 1612, which may correspond to configuration and control data used to enable adaptive audio processing cycles. These settings 1612 may be similar to or include the various configurations stored in the memory 108, such as the plurality of durations 112, the plurality of categories 114, the plurality of processing frame sizes 116, and the operating parameter 118. Such settings 1612 may be used to dynamically set or reset the processing cycle of the audio playback thread 126 based on runtime conditions, such as power state, SoC level, or playback mode as described in the foregoing description of FIG. 1-10.

In some implementations, the memory 1608 may correspond to or include the memory 108, while in other implementations the memory 108 may be distinct from the memory 1608 and coupled to the processor(s) 1602. The device 1600 may include a modem 1614 coupled, via a transceiver 1616, to an antenna 1618. In some implementations, the memory 1608 may be accessible to the modem 1614.

The device 1600 may include a display 1622 coupled to a display controller 1624. Further, speaker(s) 1620 and microphone(s) 1632 may be coupled to the CODEC 1626. The CODEC 1626 may include a digital-to-analog converter (DAC) 1628, an analog-to-digital converter (ADC) 1630, or both. In an implementation, the CODEC 1626 may receive analog signals from the microphone(s) 1632, convert the analog signals to digital signals using the ADC 1630, and provide the digital signals to the speech and music CODEC 1606. In a particular implementation, the speech and music CODEC 1606 may provide digital signals to the CODEC 1626. The CODEC 1626 may convert the digital signals to analog signals using the DAC 1628 and may provide the analog signals to the speaker(s) 1620. Further, an input device 1634 and a power supply 1636 may be coupled to the device 1600.

The device 1600 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an IoT device, an XR device, a base station, a mobile device, or any combination thereof.

Some implementation examples are described in the following numbered aspects:

Aspect 1: A method, comprising: setting a processing cycle of an audio playback thread to a first duration of a plurality of durations based on an operating parameter being within a first category of a plurality of categories; detecting a change in the operating parameter, wherein the changed operating parameter is within a second category of the plurality of categories; and resetting the processing cycle to a second duration of the plurality of durations based on the changed operating parameter being within the second category.

Aspect 2: The method of aspect 1, wherein the plurality of durations is associated with the plurality of categories, respectively, and the setting of the processing cycle to the first duration and the resetting of the processing cycle to the second duration are based on the association between the plurality of durations and the plurality of categories, respectively.

Aspect 3: The method of any of aspects 1 through 2, wherein the audio playback thread supports a plurality of processing frame sizes, each processing frame size of the plurality of processing frame sizes being associated with a respective duration of the plurality of durations, a first processing frame size among the plurality of processing frame sizes is associated with the first duration, and a second processing frame size among the plurality of processing frame sizes is associated with the second duration.

Aspect 4: The method of any of aspects 1 through 3, comprising processing first audio content having a first processing frame size during the processing cycle having the first duration; and processing second audio content having a second processing frame size during the processing cycle having the second duration, the second processing frame size being different from the first processing frame size.

Aspect 5: The method of any of aspects 1 through 4, comprising transitioning to an active state at a start of the processing cycle; processing audio content faster-than-real-time in the active state; and entering a sleep state for a residual time of the processing cycle based on a completion of the processing of the audio content.

Aspect 6: The method of any of aspects 1 through 5, comprising acquiring one or more resources based on a transition to an active state; and releasing the acquired one or more resources based on a transition to a sleep state.

Aspect 7: The method of aspect 6, wherein the one or more resources comprise at least one of a memory bandwidth of the one or more memories or a clocking resource.

Aspect 8: The method of any of aspects 1 through 7, comprising receiving an input signal to render an audio media; and launching an application thread and the audio playback thread based on the received input signal, wherein the audio playback thread at the launch has the processing cycle set to the first duration.

Aspect 9: The method of any of aspects 1 through 8, comprising periodically obtaining audio data associated with an audio media; and storing the obtained audio data in a buffer memory accessible by an application thread and the audio playback thread.

Aspect 10: The method of aspect 9, comprising periodically transitioning between an active state to obtain the audio data and a sleep state upon the storage of the obtained audio data in the buffer memory.

Aspect 11: The method of any of aspects 9 through 10, wherein the buffer memory corresponds to a circular buffer having a tail marker, the tail marker corresponds to an insertion point for the application thread to store the obtained audio data in the buffer memory, and the tail marker dynamically advances to an end of the stored audio data.

Aspect 12: The method of any of aspects 9 through 11, wherein the buffer memory corresponds to a circular buffer having a head marker, the audio playback thread is configured to obtain audio content for audio playback from the stored audio data based on the head marker, and the head marker dynamically advances to an end of the obtained audio data.

Aspect 13: The method of any of aspects 1 through 12, comprising obtaining the operating parameter, wherein the setting of the processing cycle and the resetting of the processing cycle are based on the obtained operating parameter.

Aspect 14: The method of any of aspects 1 through 13, comprising obtaining the operating parameter through an application thread associated with the audio playback thread.

Aspect 15: The method of any of aspects 1 through 13, comprising obtaining the operating parameter based on at least one of real-time monitoring, periodic sampling, or a trigger event.

Aspect 16: The method of any of aspects 1 through 15, comprising outputting audio signal based on the processing cycle being set to the first duration; and updating the output of the audio signal based on the processing cycle being reset to the second duration.

Aspect 17: The method of any of aspects 1 through 16, wherein the operating parameter corresponds to a state of charge (SoC) associated with the device and the plurality of categories corresponds to a plurality of SoC ranges, respectively, the first category corresponds to a first SoC range in the plurality of SoC ranges, and the second category corresponds to a second SoC range in the plurality of SoC ranges.

Aspect 18: The method of any of aspects 1 through 17, wherein in a case where the second duration is greater than the first duration, a first power consumption associated with the audio playback thread having the processing cycle set to the first duration is higher than a second power consumption associated with the audio playback thread having the processing cycle reset to the second duration.

Aspect 19: The method of any of aspects 1 through 17, wherein in a case where the first duration is greater than the second duration, a first power consumption associated with the audio playback thread having the processing cycle set to the first duration is lower than a second power consumption associated with the audio playback thread having the processing cycle reset to the second duration.

Aspect 20: A method, comprising: setting a processing cycle of an audio playback thread to a first duration of a plurality of durations based on a state of charge (SoC) of a rechargeable power source being within a first SoC range of a plurality of SoC ranges; detecting a change in the SoC, wherein the changed SoC is within a second SoC range of the plurality of SoC ranges; and resetting the processing cycle to a second duration of the plurality of durations based on the changed SoC being within the second SoC range.

Aspect 21: A device, comprising one or more memories; and one or more processors coupled to the one or more memories, the one or more processors individually or collectively configured to perform a method of any of aspects 1 through 19.

Aspect 22: A device, comprising at least one means for performing a method of any of aspects 1 through 19.

Aspect 23: A non-transitory computer-readable medium storing code for audio playback with an adaptive processing cycle at a device, the code comprising instructions executable by a processor to perform a method of any of aspects 1 through 19.

Aspect 24: A device, comprising: a rechargeable power source, one or more memories; and one or more processors coupled to the one or more memories and the rechargeable power source, the one or more processors individually or collectively configured to perform a method of aspect 20.

Aspect 25: A device, comprising at least one means for performing a method of any of aspect 20.

Aspect 26: A non-transitory computer-readable medium storing code for audio playback with an adaptive processing cycle at a device, the code comprising instructions executable by a processor to perform a method of aspect 20.

It is understood that the specific order or hierarchy of steps in the processes disclosed is an illustration of example approaches. Based on design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

As used herein, the phrase ‘one or more processors individually or collectively configured to’ may encompass various aspects, including but not limited to: processors that are programmed and capable of performing the function, regardless of whether execution is occurring at a given time; processors actively executing instructions to perform the function; and processors that, when triggered by an event or condition, initiate execution of the function. The phrase does not limit the scope of the disclosure to an actively functioning device.

As used herein, the phrase ‘one or more processors individually or collectively configured to’ may encompass various aspects, including but not limited to: a single processor executing all functions; multiple processors, each performing different aspects of the function independently; multiple processors operating in coordination to execute a function collectively; or any combination thereof, where different processors may dynamically (e.g., concurrently or sequentially) assume responsibilities based on system conditions.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessor(s), one or more microprocessor(s) in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Further, the examples provided throughout the present disclosure are intended for illustrative purposes and, as such, are not intended to limit the scope of the disclosure.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disks and discs, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. A device, comprising:
one or more memories configured to store data related to a plurality of durations; and
one or more processors coupled to the one or more memories, the one or more processors individually or collectively configured to:
set a processing cycle of an audio playback thread to a first duration of the plurality of durations based on an operating parameter associated with the device being within a first category of a plurality of categories;
detect a change in the operating parameter, wherein the changed operating parameter is within a second category of the plurality of categories; and
reset the processing cycle to a second duration of the plurality of durations based on the changed operating parameter being within the second category.

2. The device of claim 1, wherein
the plurality of durations is associated with the plurality of categories, respectively, and
the setting of the processing cycle to the first duration and the resetting of the processing cycle to the second duration are based on the association between the plurality of durations and the plurality of categories, respectively.

3. The device of claim 1, wherein
the audio playback thread is configured to support a plurality of processing frame sizes, each processing frame size of the plurality of processing frame sizes being associated with a respective duration of the plurality of durations,
a first processing frame size among the plurality of processing frame sizes is associated with the first duration, and
a second processing frame size among the plurality of processing frame sizes is associated with the second duration.

4. The device of claim 1, wherein the audio playback thread is configured to:
process first audio content having a first processing frame size during the processing cycle having the first duration; and
process second audio content having a second processing frame size during the processing cycle having the second duration, the second processing frame size being different from the first processing frame size.

5. The device of claim 1, wherein the audio playback thread is configured to:
transition to an active state at a start of the processing cycle;
process audio content faster-than-real-time in the active state; and
enter a sleep state for a residual time of the processing cycle based on a completion of the processing of the audio content.

6. The device of claim 1, wherein the audio playback thread is configured to:
acquire one or more resources based on a transition to an active state; and
release the acquired one or more resources based on a transition to a sleep state.

7. The device of claim 6, wherein the one or more resources comprise at least one of a memory bandwidth of the one or more memories or a clocking resource.

8. The device of claim 1, wherein the one or more processors are individually or collectively configured to:
receive an input signal to render an audio media; and
launch an application thread and the audio playback thread based on the received input signal, wherein the audio playback thread at the launch has the processing cycle set to the first duration.

9. The device of claim 1, comprising a buffer memory accessible by an application thread and the audio playback thread, wherein the application thread is configured to:
periodically obtain audio data associated with an audio media; and
store the obtained audio data in the buffer memory.

10. The device of claim 9, wherein the application thread is configured to periodically transition between an active state to obtain the audio data and a sleep state upon the storage of the obtained audio data in the buffer memory.

11. The device of claim 9, wherein
the buffer memory corresponds to a circular buffer including a tail marker,
the tail marker corresponds to an insertion point for the application thread to store the obtained audio data in the buffer memory, and
the tail marker is configured to dynamically advance to an end of the stored audio data.

12. The device of claim 9, wherein
the buffer memory corresponds to a circular buffer including a head marker,
the audio playback thread is configured to obtain audio content for audio playback from the stored audio data based on the head marker, and
the head marker is configured to dynamically advance to an end of the obtained audio content.

13. The device of claim 1, wherein the one or more processors are individually or collectively configured to obtain the operating parameter, wherein the setting of the processing cycle and the resetting of the processing cycle are based on the obtained operating parameter.

14. The device of claim 1, wherein the one or more processors are individually or collectively configured to obtain the operating parameter through an application thread associated with the audio playback thread.

15. The device of claim 1, wherein the one or more processors are individually or collectively configured to obtain the operating parameter based on at least one of real-time monitoring, periodic sampling, or a trigger event.

16. The device of claim 1, comprising one or more speakers configured to:
output an audio signal based on the processing cycle being set to the first duration; and
update the output of the audio signal based on the processing cycle being reset to the second duration.

17. The device of claim 1, wherein
the operating parameter corresponds to a state of charge (SoC) associated with the device and the plurality of categories corresponds to a plurality of SoC ranges, respectively,
the first category corresponds to a first SoC range in the plurality of SoC ranges, and
the second category corresponds to a second SoC range in the plurality of SoC ranges.

18. The device of claim 1, wherein in a case where the second duration is greater than the first duration, a first power consumption associated with the audio playback thread having the processing cycle set to the first duration is higher than a second power consumption associated with the audio playback thread having the processing cycle reset to the second duration.

19. The device of claim 1, wherein in a case where the first duration is greater than the second duration, a first power consumption associated with the audio playback thread having the processing cycle set to the first duration is lower than a second power consumption associated with the audio playback thread having the processing cycle reset to the second duration.

20. A device, comprising:
a rechargeable power source;
one or more memories configured to store data related to a plurality of durations; and
one or more processors coupled to the one or more memories and the rechargeable power source, the one or more processors individually or collectively configured to:
set a processing cycle of an audio playback thread to a first duration of the plurality of durations based on a state of charge (SoC) of the rechargeable power source being within a first SoC range of a plurality of SoC ranges;
detect a change in the SoC, wherein the changed SoC is within a second SoC range of the plurality of SoC ranges; and
reset the processing cycle to a second duration of the plurality of durations based on the changed SoC being within the second SoC range.
